(19) United States
(12) Patent Application Publication
(10) Pub. No.: US 2015/0062164 A1
(43) Pub. Date: Mar. 5, 2015

(54) HEAD MOUNTED DISPLAY, METHOD OF CONTROLLING HEAD MOUNTED DISPLAY, COMPUTER PROGRAM, IMAGE DISPLAY SYSTEM, AND INFORMATION PROCESSING APPARATUS

(71) Applicant: SEIKO EPSON CORPORATION, Tokyo (JP)

(72) Inventors: Shinichi KOBAYASHI, Azumino-shi (JP); Masahide TAKANO, Matsumoto-shi (JP)

(21) Appl. No.: 14/454,302

(22) Filed: Aug. 7, 2014

(30) Foreign Application Priority Data
Sep. 5, 2013 (JP) 2013-183631
May 23, 2014 (JP) 2014-106842

(51) Int. Cl. G06T 19/00; G06T 11/60

(52) U.S. Cl. CPC G06T 19/006; G06T 11/60; G06T 2215/16; G06T 2210/61
USPC 345/633

(57) ABSTRACT

A head mounted display which allows a user to visually recognize a virtual image and external scenery, includes a generation unit that generates a list image including a first image which is a display image of an external apparatus connected to the head mounted display and a second image of the head mounted display, and an image display unit that forms the virtual image indicating the generated list image.

### BACKGROUND

1. Technical Field

The present invention relates to a head mounted display.

2. Related Art

A head mounted display (HMD) which is a display mounted on the head is known. The head mounted display generates image light representing an image by using, for example, a liquid crystal display and a light source, and guides the generated image light to user's eyes by using a projection optical system or a light guide plate, thereby allowing the user to recognize a virtual image. The head mounted display is connected to an external apparatus such as a smart phone via a wired interface such as a micro-universal serial bus (USB), and receives a video signal from the external apparatus in accordance with a standard such as Mobile High definition Link (MHL). Similarly, the head mounted display is connected to an external apparatus via a wireless interface such as a wireless LAN, and receives a video signal from the external apparatus in accordance with a standard such as Miracast. The head mounted display allows a user of the head mounted display to visually recognize the same virtual image as an image (display image) which is displayed on a display screen of the external apparatus on the basis of the video signal received as mentioned above.

JP-A-2013-92781 discloses a configuration in which a display destination is determined depending on open and close states of a portable information terminal when a predetermined function mounted in the portable information terminal is displayed on either a display screen of the portable information terminal or a display screen of a head mounted display. JP-A-2000-284886 discloses a text input system which includes a unit detecting an operation of each finger and a unit generating a code such as a text code by analyzing the detected operation, in order to enable text to be input to a head mounted display with a single hand anytime and anywhere. JP-A-2000-29619 discloses a virtual mouse for providing an input unit with good intuition property and visibility to a head mounted display. Japanese Patent No. 5037718 discloses a simple operation type wireless data transmission and reception system which transmits and receives electronic data between a plurality of electronic apparatuses in a wireless communication method of Wi-Fi infrastructure mode.

In the technique disclosed in JP-A-2013-92781, there is a problem in that only a predetermined function mounted in the portable information terminal is taken into consideration, and display of a function mounted in the head mounted display is not taken into consideration. In addition, in the techniques disclosed in JP-A-2000-284886, JP-A-2000-29619, and Japanese Patent No. 5037718, there is a problem in that displaying a display image of other apparatuses on the head mounted display is not taken into consideration.

For this reason, a head mounted display which allows a user to visually recognize both a display image of the head mounted display and a display image of an external apparatus connected to the head mounted display is desirable. In addition, in the head mounted display, there are various demands for improvement of usability, improvement of versatility, improvement of convenience, improvement of reliability, and manufacturing cost reduction.

### SUMMARY

An advantage of some aspects of the invention is to solve at least a part of the problems described above, and the invention can be implemented as the following aspects.

(1) An aspect of the invention provides a head mounted display which allows a user to visually recognize a virtual image and external scenery. The head mounted display includes a generation unit that generates a list image including a first image which is a display image of an external apparatus connected to the head mounted display and a second image of the head mounted display; and an image display unit that forms the virtual image indicating the generated list image. According to the head mounted display, the image display unit forms the virtual image indicating the list image including the first image which is a display image of the external apparatus connected to the head mounted display and the second image of the head mounted display, and allows the user to visually recognize the virtual image. For this reason, it is possible to provide a head mounted display which allows a user to visually recognize both a display image of the head mounted display and a display image of an external apparatus.

(2) The head mounted display of the aspect described above may further include an acquisition unit that acquires the first image from the external apparatus, and the generation unit may generate the list image in which the acquired first image is disposed in a first region, and the second image is disposed in a second region different from the first region. According to the head mounted display of this aspect, the generation unit can easily generate the list image by disposing the first image acquired from the external apparatus in the first region and the second image of the head mounted display in the second region.

(3) In the head mounted display of the aspect described above, the generation unit may use an image which is currently displayed on the head mounted display as the second image. According to the head mounted display of this aspect, the generation unit can generate the list image by using a display image of the head mounted display as the second image without change. For this reason, it is possible to make process content in the generation unit concise.

(4) In the head mounted display of the aspect described above, the generation unit may generate the second image by changing an arrangement of icon images of the head mounted display. According to the head mounted display of this aspect, the generation unit can generate the second image whose aspect ratio is freely changed by changing an arrangement of icon images of the head mounted display, and can generate a list image by using the generated second image.

(5) In the head mounted display of the aspect described above, the generation unit may further perform at least one of change of shapes, change of transmittance, change of colors, change of sizes, and addition of decorations, on the icon image when the second image is generated. According to the head mounted display of this aspect, the generation unit performs at least one of change of shapes, change of transmittance, change of colors, change of sizes, and addition of decorations, on the icon image of the head mounted display when the second image is generated. As a result, a user can easily differentiate the icon image of the head mounted display in the list image.

(6) In the head mounted display of the aspect described above, the generation unit may further change a size of at least one of the first image and the second image, and generates the list image by using the changed image. According to the head mounted display of this aspect, the generation unit can change a size of the first image so as to match a size of the first region. In addition, the generation unit can change a size of the simultaneously so as to match a size of the second region.

(7) In the head mounted display of the aspect described above, the generation unit may further perform a process corresponding to at least one of change of shapes, change of transmittance, change of colors, change of sizes, and addition of decorations, on at least one of the first image and the second image, and generates the list image by using the image having undergone the process. According to the head mounted display of this aspect, the generation unit can perform a process corresponding to at least one of change of shapes, change of transmittance, change of colors, change of sizes, and addition of decorations, on at least one of the first image and the second image. As a result, a user easily differentiates the first image from the second image in the list image.

(8) The head mounted display of the aspect described above may further include an operation acquisition unit that acquires an operation on the list image performed by the user; and a first notification unit that notifies the external apparatus of the operation when the acquired operation is an operation on the first image. According to the head mounted display of this aspect, the first notification unit notifies the external apparatus of a user's operation on the first image of the list image. For this reason, a user can operate an external apparatus via an input interface of the head mounted display, and thus it is possible to improve usability of the head mounted display.

(9) In the head mounted display of the aspect described above, the image display unit may form the virtual image in which a pointer image is further superimposed on the list image, and the generation unit may make the pointer image superimposed on the first image different from the pointer image superimposed on the second image. According to the head mounted display of this aspect, the image display unit allows a user to visually recognize the pointer image superimposed on the first image and the pointer image superimposed on the second image as different images (virtual images). As a result, a user easily differentiates whether an operation target of the user in the list image is the external apparatus indicated by the first image or the head mounted display indicated by the second image.

(10) In the head mounted display of the aspect described above, the generation unit may further perform at least one of change of shapes, change of transmittance, change of colors, change of sizes, and addition of decorations, on at least one of the pointer image superimposed on the first image and the pointer image superimposed on the second image, so as to make the pointer images different from each other. According to the head mounted display of this aspect, the generation unit causes at least one of change of shapes, change of transmittance, change of colors, change of sizes, and addition of decorations, to be performed on at least one of the pointer image superimposed on the first image and the pointer image superimposed on the second image. As a result, a user easily differentiates the pointer images in the list image.

(11) In the head mounted display of the aspect described above, the image display unit may form the virtual image in which a pointer image is further superimposed on the list image, and the head mounted display may further include a second notification unit that notifies the external apparatus of positional information for superimposing a pointer image for the external apparatus at a position corresponding to a position at which the pointer image is superimposed in a display image of the external apparatus, when the pointer image is superimposed on the first image. According to the head mounted display of this aspect, the second notification unit notifies the external apparatus of positional information for superimposing a pointer image for the external apparatus at a position corresponding to a position at which the pointer image is superimposed in a display image of the external apparatus, when the pointer image is superimposed on the first image. For this reason, the external apparatus can display the pointer image for an external apparatus on the basis of the acquired positional information. As a result, a user of the external apparatus can visually recognize a pointer image on the first image of the head mounted display in the external apparatus. In other words, display of a pointer in the head mounted display can be shared by the external apparatus.

(12) In the head mounted display of the aspect described above, the image display unit may form the virtual image in which the pointer image is superimposed, at a position determined on the basis of at least one of a motion of an indicator on an input device of the head mounted display and a motion of a visual line of the user. According to the head mounted display of this aspect, the head mounted display can determine a position of the pointer image on the basis of at least one of a motion of an indicator on an input device of the head mounted display and a motion of a visual line of the user.

(13) In the head mounted display of the aspect described above, the acquisition unit may acquire the first image from the external apparatus, and acquires a third image which is a display image of another external apparatus from another external apparatus, and the generation unit may generate the list image in which the third image is disposed in a third region different from the first region and the second region. According to the head mounted display of this aspect, even in a case where a plurality of apparatuses are connected as external apparatuses, it is possible to provide a head mounted display which allows a user to visually recognize a display image of the head mounted display and a display image of the external apparatus.

(14) Another aspect of the invention provides an image display system. The image display system includes a head mounted display that allows a user to visually recognize a virtual image and external scenery; and an external apparatus that is connected to the head mounted display, in which the external apparatus includes a transmission unit that acquires a first image which is a display image of the external apparatus, and transmits the acquired first image to the head mounted display, and in which the head mounted display includes a generation unit that generates a list image including the first image and a second image of the head mounted display; and an image display unit that forms the virtual image indicating the generated list image.

(15) Still another aspect of the invention provides an information processing apparatus which is connected to a head mounted display and generates an image to be displayed on the head mounted display. The information processing apparatus includes an acquisition unit that acquires a first image which is a display image of an external apparatus connected to the head mounted display and a second image of the head mounted display; a list image generation unit that generates a list image including the acquired first image and second image; and a list image transmission unit that transmits the generated list image to the head mounted display. According to the information processing apparatus of this aspect, it is possible to achieve the same effect as the effects of the above aspects by using the information processing apparatus connected to the head mounted display.

All of the plurality of constituent elements in the respective aspects of the invention described above are not essential, and some of the plurality of constituent elements may be changed, deleted, exchanged with other new constituent elements, and partially deleted from limited content thereof, as appropriate, in order to solve some or all of the above-described problems or in order to achieve some or all of the effects described in the present specification. In addition, in order to solve some or all of the above-described problems or in order to achieve some or all of the effects described in the present specification, some or all of the technical features included in one aspect of the invention described above may be combined with some or all of the technical features included in another aspect of the invention described above, and as a result may be treated as an independent aspect of the invention.

For example, one aspect of the invention may be implemented as a device which includes some or both of the two constituent elements including the generation unit and the image display unit. In other words, this device may or may not include the generation unit. Further, the device may or may not include the image display unit. This device may be implemented as, for example, a head mounted display, but may be implemented as devices other than the head mounted display. Some or all of the above-described technical features of each aspect of the head mounted display are applicable to the device.

The invention may be implemented in various aspects, and may be implemented in aspects such as a head mounted display, a control method for the head mounted display, an image display system using the head mounted display, a computer program for implementing functions of the method, the display, and the system, and a recording medium for recording the computer program thereon.

### BRIEF DESCRIPTION OF THE DRAWINGS

The invention will be described with reference to the accompanying drawings, wherein like numbers reference like elements.

FIG. 1 is a diagram illustrating a schematic configuration of an image display system according to an embodiment of the invention.

FIG. 2 is a functional block diagram illustrating a configuration of a head mounted display.

FIG. 3 is a diagram illustrating an example of region information stored in a region information storage portion.

FIG. 4 is a diagram illustrating an example of a virtual image which is visually recognized by a user.

FIG. 5 is a sequence diagram illustrating a procedure of an arrangement process.

FIG. 6 is a diagram illustrating a state in which a list image is displayed on the head mounted display.

FIGS. 7A and 7B are diagrams illustrating change of a pointer image in the list image.

FIG. 8 is a sequence diagram illustrating a procedure of a notification process.

FIGS. 9A and 9B are diagrams illustrating step S202 of the notification process.

FIG. 10 is a functional block diagram illustrating a configuration of a head mounted display according to a second embodiment.

FIG. 11 is a diagram illustrating an example of a frame stored in frame information.

FIG. 12 is a sequence diagram illustrating a procedure of an arrangement process in the second embodiment.

FIG. 13 is a diagram illustrating a state in which a list image is displayed on the head mounted display.

FIG. 14 is a diagram illustrating a schematic configuration of an image display system according to a third embodiment.

FIG. 15 is a functional block diagram illustrating a configuration of a head mounted display according to the third embodiment.

FIG. 16 is a diagram illustrating an example of region information stored in a region information storage portion in the third embodiment.

FIG. 17 is a sequence diagram illustrating a procedure of an arrangement process in the third embodiment.

FIG. 18 is a diagram illustrating a state in which a list image is displayed on the head mounted display.

FIG. 19 is a sequence diagram illustrating a procedure of a pointer notification process in the third embodiment.

FIG. 20 is a diagram illustrating a state in which a pointer image is superimposed on a list image so as to be displayed on the head mounted display.

FIG. 21 is a diagram illustrating a state in which a pointer image is superimposed on a list image so as to be displayed on the head mounted display as an external apparatus.

FIG. 22 is a sequence diagram illustrating a procedure of a notification process in the third embodiment.

FIG. 23 is a diagram illustrating steps S600 to S606 of the notification process in the third embodiment.

FIGS. 24A and 24B are diagrams illustrating exterior configurations of head mounted displays in a modification example.

### DESCRIPTION OF EXEMPLARY EMBODIMENTS

### A. First Embodiment

### A-1. Configuration of Image Display System

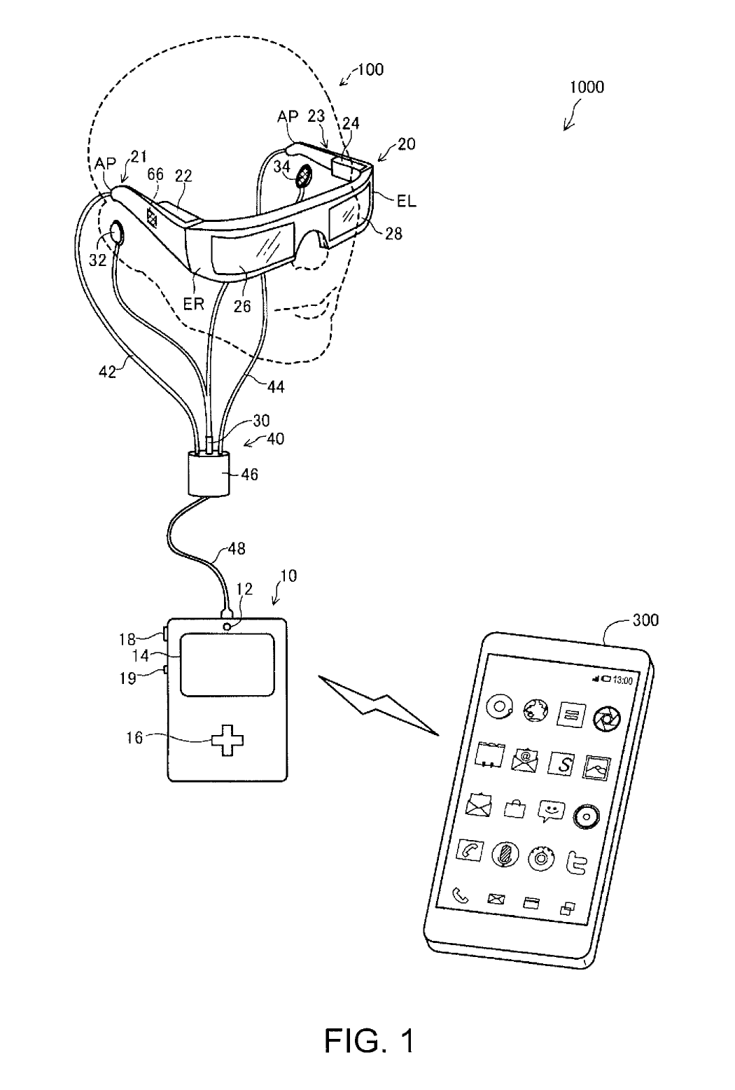

FIG. 1 is a diagram illustrating a schematic configuration of an image display system 1000 according to an embodiment of the invention. The image display system 1000 includes a head mounted display 100 and a portable information terminal 300 as an external apparatus. The image display system 1000 displays a list image including a display image of the portable information terminal 300 and an image of the headmounted display 100 on the headmounted display 100. Here, the “display image of the portable information terminal 300 (also referred to as a smart phone 300)” indicates an image which is currently displayed on a display screen of the smart phone 300. In addition, the display image of the smart phone 300 includes an image which is to be displayed on the display screen but is not displayed as a result of output to an external apparatus. Further, the “image of the head mounted display 100” indicates an image which is currently displayed on a display screen of the head mounted display 100. Furthermore, the image of the head mounted display 100 includes an image which is to be displayed on the display screen but is not displayed as a result of output to an external apparatus.

The head mounted display 100 is a display mounted on the head. The head mounted display 100 according to the present embodiment is an optical transmission type head mounted display which allows a user to visually recognize a virtual image and also to directly visually recognize external scenery. The portable information terminal 300 is a portable information communication terminal. In the present embodiment, a smart phone is an example of the portable information terminal. The head mounted display 100 and the smart phone 300 are connected to each other so as to perform wireless communication or wired communication.

### A-2. Configuration of Head Mounted Display

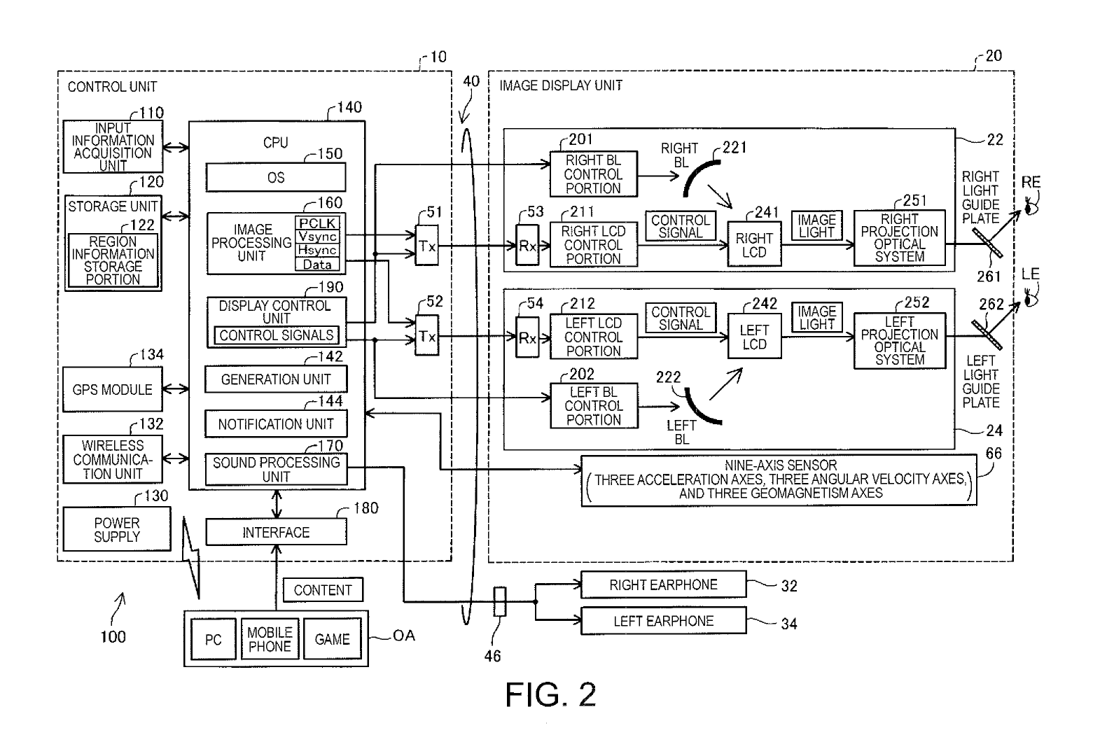

FIG. 2 is a functional block diagram illustrating a configuration of the head mounted display 100. As illustrated in FIGS. 1 and 2, the head mounted display 100 includes an image display unit 20 which allows the user to visually recognize a virtual image in a state of being mounted on the head of the user, and a control unit 10 (a controller) which controls the image display unit 20. The image display unit 20 and the control unit 10 are connected to each other via a connection unit 40, and transmit various signals via the connection unit 40. The connection unit 40 employs a metal cable or an optical fiber.

### A-2-1. Configuration of Control Unit

The control unit 10 is a device which controls the head mounted display 100. The control unit 10 includes an input information acquisition unit 110, a storage unit 120, a power supply 130, a wireless communication unit 132, a GPS module 134, a CPU 140, an interface 180, and transmission units (Tx) 51 and 52, and the above-described constituent elements are connected to each other via a bus (not illustrated) (FIG. 2).

The input information acquisition unit 110 acquires a signal based on an operation input which is performed on, for example, an input device such as a touch pad, a cross key, a foot switch (a switch operated by the leg of the user), a gesture detection device (which detects a gesture of the user with a camera or the like, and acquires an operation input based on a command correlated with the gesture), a visual line detection device (which detects a visual line of the user with an infrared sensor or the like, and acquires an operation input based on a command correlated with a motion of the visual line), or a microphone. In addition, when a gesture is detected, a finger tip of the user, a ring worn by the user, a tool held with the user's hand, or the like may be used as a marker for detecting a motion. If an operation input is acquired by using the foot switch, the visual line detection device, or the microphone, it is possible to considerably improve convenience for the user in a case where of using the head mounted display 100 in sites (for example, a medical site, or a site requiring hand work in a construction or manufacturing industry) where it is difficult for the user to perform an operation with the hand.

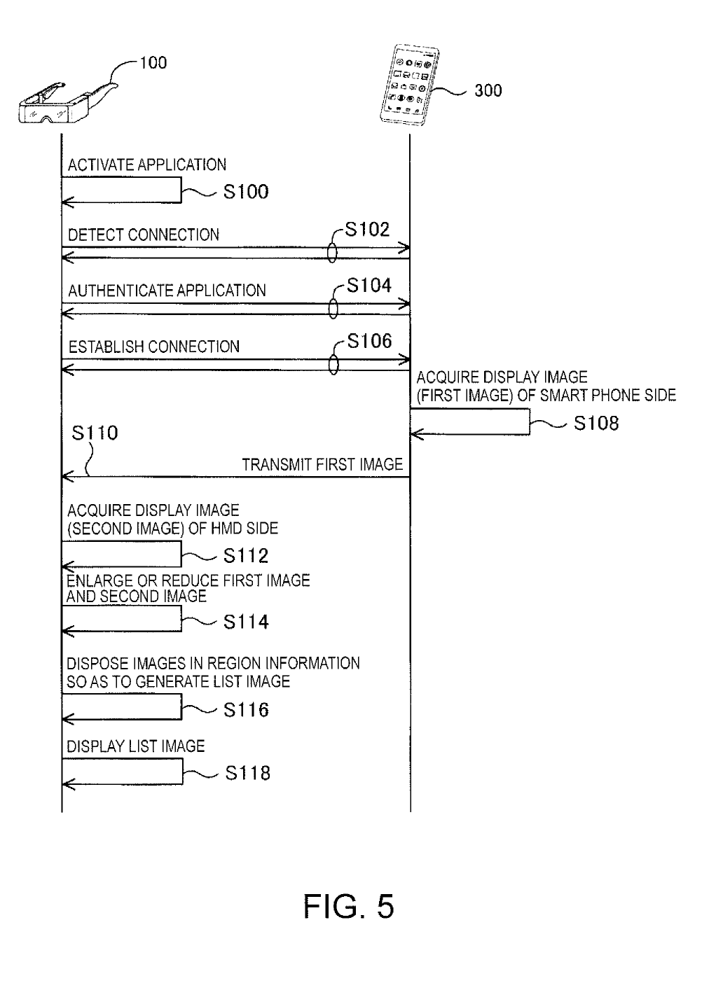

The storage unit 120 is constituted by a ROM, a RAM, a DRAM, a hard disk, or the like. The storage unit 120 includes a region information storage portion 122. The region information storage portion 122 stores at least one piece of region information. The region information is information for defining a region of a list image which is generated in an arrangement process (FIG. 5). In other words, the region information is used as a range for arranging an image of the head mounted display 100 and a display image of the smart phone 300.

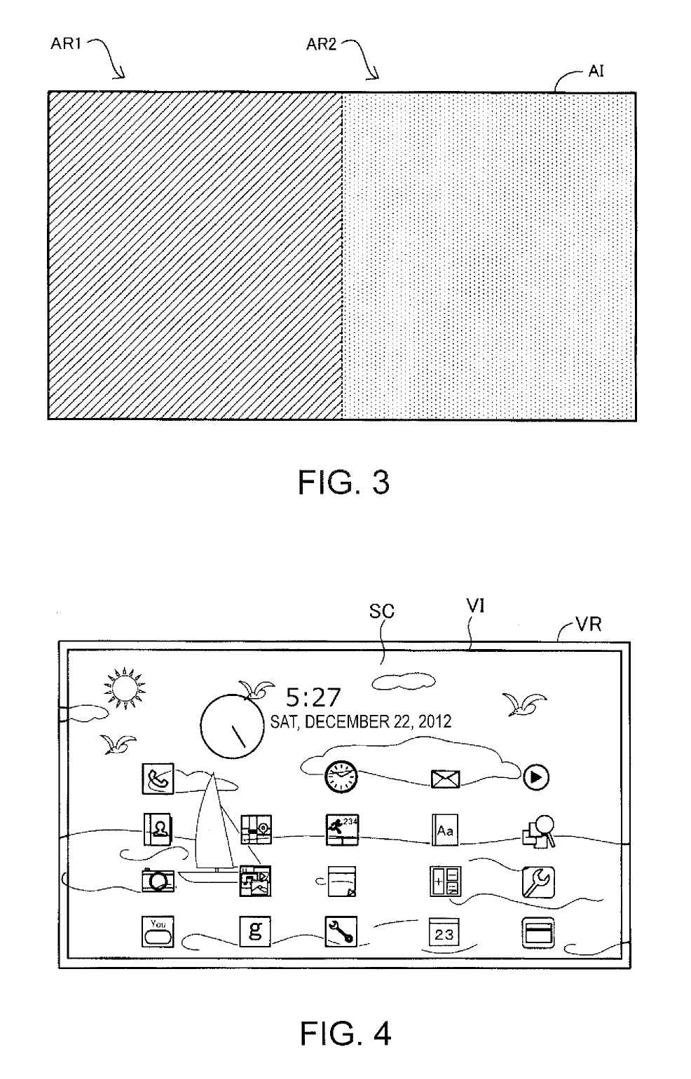

FIG. 3 is a diagram illustrating an example of region information stored in the region information storage portion 122. Region information AI illustrated in FIG. 3 includes a rectangular region (hereinafter, also referred to as a “region AI”). The region AI preferably has the same aspect ratio as an aspect ratio of a display element (in FIG. 2, a right LCD 241 or a left LCD 242) of the head mounted display 100.

The region AI includes a first region AR1 and a second region AR2. The first region AR1 is a region in which a display image of the smart phone 300 is disposed in the arrangement process (FIG. 5). The second region AR2 is a region in which an image of the head mounted display 100 is disposed in the arrangement process. In the example of FIG. 3, the first region AR1 is disposed in one of horizontally equally divided parts of the region AI, and the second region AR2 is disposed in the other of the horizontally equally divided parts of the region AI. In other words, the first region AR1 and the second region AR2 have the same size.

In addition, the arrangement and the size of the first region AR1 and the second region AR2 illustrated in FIG. 3 are an example, and may be arbitrarily set. For example, the first region AR1 and the second region AR2 may have sizes in which the region AI is equally divided into n (where n is an integer of 3 or more) in a horizontal direction. In this case, when a list image generated by using the region information AI is displayed on the head mounted display 100, the first region AR1 and the second region AR2 are preferably disposed at ends (left and right ends) of the region AI from the viewpoint of not impeding a visual line of the user. In addition, the first region AR1 and the second region AR2 may have sizes in which the region AI is equally divided into m (where m is an integer of 2 or more) in a vertical direction. Here, in a case where m is 3 or more, the first region AR1 and the second region AR2 are preferably disposed at ends (upper and lower ends) of the region AI. In addition, the first region AR1 and the second region AR2 may have different sizes. Further, the first region AR1 and the second region AR2 may overlap each other in at least a part thereof.

The power supply 130 supplies power to the respective units of the head mounted display 100. For example, a secondary battery may be used as the power supply 130. The wireless communication unit 132 performs wireless communication with external apparatuses in accordance with a predetermined wireless communication standard (for example, infrared rays, near field communication exemplified in Bluetooth (registered trademark), or a wireless LAN exemplified in IEEE 802.11). External apparatuses indicate apparatuses other than the head mounted display 100, and include not only the smart phone 300 illustrated in FIG. 1, but also a tablet, a personal computer, a gaming terminal, an audio video (AV) terminal, a home electric appliance, and the like. The GPS module 134 receives a signal from a GPS satellite, and detects a present position of a user of the head mounted display 100 so as to generate present position information indicating the present position of the user. The present position information may be implemented by coordinates indicating, for example, latitude and longitude.

The CPU 140 reads and executes the computer programs stored in the storage unit 120 so as to function as a generation unit 142, a notification unit 144, an operating system (OS) 150, an image processing unit 160, a sound processing unit 170, and a display control unit 190.

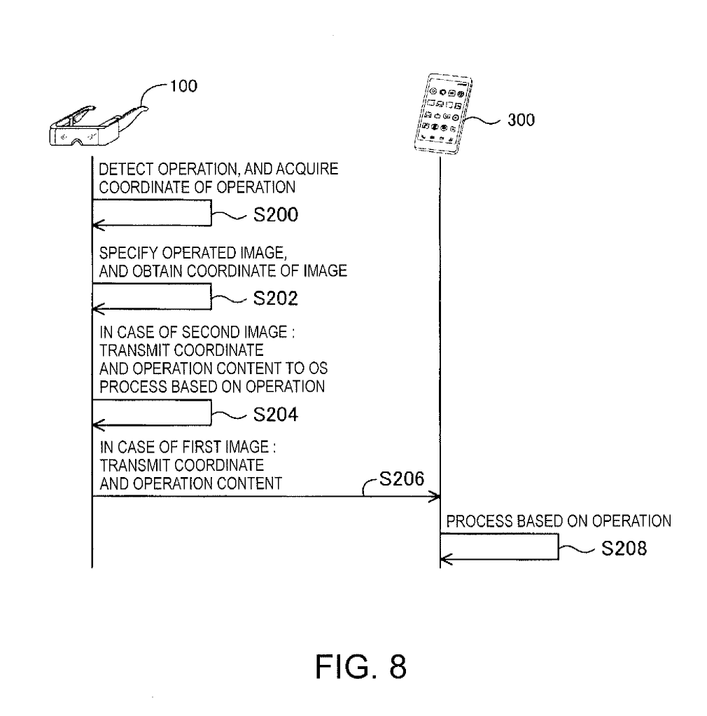

The generation unit 142 generates a list image by using an image of the head mounted display 100 and a display image of the smart phone 300 in an arrangement process (FIG. 4). The notification unit 144 notifies the smart phone 300 of operation content when an operation is performed on the display image of the smart phone 300 in the list image in a notification process (FIG. 8).

The image processing unit 160 generates signals on the basis of a video signal which is input from the generation unit 142, the interface 180, the wireless communication unit 132, or the like via the OS 150. The image processing unit 160 supplies the generated signals to the image display unit 20 via the connection unit 40, so as to control display in the image display unit 20. The signals supplied to the image display unit 20 are different in cases of an analog format and a digital format.

For example, in a case of a digital format, a video signal is input in which a digital R signal, a digital G signal, a digital B signal, and a clock signal PCLK are synchronized with each other. The image processing unit 160 may perform, on image data Data formed by the digital R signal, the digital G signal, and the digital B signal, image processes including a well-known resolution conversion process, various color tone correction processes such as adjustment of luminance and color saturation, a keystone correction process, and the like, as necessary. Then, the image processing unit 160 transmits the clock signal PCLK and the image data Data via the transmission units 51 and 52.

In a case of an analog format, a video signal is input in which an analog R signal, an analog G signal, an analog B signal, a vertical synchronization signal VSync, and a horizontal synchronization signal HSync are synchronized with each other. The image processing unit 160 separates the vertical synchronization signal. VSync and the horizontal synchronization signal HSync from the input signal, and generates a clock signal PCLK by using a PLL circuit (not illustrated) in accordance with cycles of the signals. In addition, the image processing unit 160 converts the analog R signal, the analog G signal, and the analog B signal into digital signals by using an A/D conversion circuit or the like. The image processing unit 160 performs well-know image processes on image data Data formed by converted digital R signal, digital G signal, and digital B signal, as necessary, and then transmits the clock signal PCLK, the image data Data, the vertical synchronization signal VSync, and the horizontal synchronization signal HSync via the transmission units 51 and 52. Further, hereinafter, image data Data which is transmitted via the transmission unit 51 is referred to as “right eye image data Data1”, and image data Data which is transmitted via the transmission unit 52 is referred to as “left eye image data Data2”.

The display control unit 190 generates control signals for control of a right display driving unit 22 and a left display driving unit 24 included in the image display unit 20. The control signals are signals for individually causing a right LCD control portion 211 to turn on and off driving of a right LCD 241, a right backlight control portion 201 to turn on and off driving of a right backlight 221, a left LCD control portion 212 to turn on and off driving of a left LCD 242, and a left backlight control portion 202 to turn on and off driving of a left backlight 222. The display control unit 190 controls each of the right display driving unit 22 and the left display driving unit 24 to generate and emit image light. The display control unit 190 transmits the generated control signals via the transmission units 51 and 52.

The sound processing unit 170 acquires an audio signal included in the content so as to amplify the acquired audio signal, and supplies the amplified audio signal to a speaker (not illustrated) of a right earphone 32 and a speaker (not illustrated) of a left earphone 34.

The interface 180 performs wireless communication with external apparatuses in accordance with predetermined wired communication standards (for example, Micro-universal serial bus (USB), USB, High Definition Multimedia Interface (HDMI, registered trademark), Digital Visual Interface (DVI), Video Graphic Array (VGA), Composite, RS-232C (Recommended Standard 232), and a wired LAN exemplified in IEEE 802.3). The external apparatuses indicate apparatuses other than the head mounted display 100, and include not only the smart phone 300 illustrated in FIG. 1 but also a tablet, a personal computer, a gaming terminal, an AV terminal, a home electric appliance, and the like.

### A-2-2. Configuration of Image Display Unit

The image display unit 20 is a mounting body which is mounted on the head of the user, and has a glasses shape in the present embodiment. The image display unit 20 includes the right display driving unit 22, the left display driving unit 24, a right optical image display unit 26 (FIG. 1), a left optical image display unit 28 (FIG. 1), and a nine-axis sensor 66.

The right display driving unit 22 and the left display driving unit 24 are disposed at locations opposing the head of the user when the user wears the image display unit 20. In the present embodiment, the right display driving unit 22 and the left display driving unit 24 generates image light representing an image by using a liquid crystal display (hereinafter, referred to as an “LCD”) or a projection optical system, and emits the image light. The right display driving unit 22 includes a reception portion (Rx) 53, the right backlight (BL) control portion 201 and the right backlight (BL) 221 which function as a light source, the right LCD control portion 211 and the right LCD 241 which function as a display element, and a right projection optical system 251.

The reception portion 53 receives data which is transmitted from the transmission unit 51. The right backlight control portion 201 drives the right backlight 221 on the basis of an input control signal. The right backlight 221 is a light emitting body such as an LED or an electroluminescent element (EL). The right LCD control portion 211 drives the right LCD 241 on the basis of the clock signal PCLK, the right eye image data Data1, the vertical synchronization signal VSync, and the horizontal synchronization signal HSync, which are input. The right LCD 241 is a transmissive liquid crystal panel in which a plurality of pixels are arranged in a matrix. The right LCD 241 drives liquid crystal at each position of the pixels which are arranged in matrix, so as to change transmittance of light which is transmitted through the right LCD 241, thereby modulating illumination light which is applied from the right backlight 221 into effective image light representing an image. The right projection optical system 251 is constituted by a collimator lens which converts image light emitted from the right LCD 241 into parallel beams of light flux.

The left display driving unit 24 has substantially the same configuration as that of the right display driving unit 22, and operates in the same manner as the right display driving unit 22. In other words, the left display driving unit 24 includes a reception portion (Rx) 54, the left backlight (BL) control portion 202 and the left backlight (BL) 222 which function as a light source, the left LCD control portion 212 and the left LCD 242 which function as a display element, and a left projection optical system 252. Detailed description thereof will be omitted. In addition, in the present embodiment, the backlight type is employed in the present embodiment, but there may be a configuration in which image light is emitted using a front light type or a reflective type.

The right optical image display unit 26 and the left optical image display unit 28 are disposed so as to be located in front of the eyes of the user when the user wears the image display unit 20 (refer to FIG. 1). The right optical image display unit 26 includes a right light guide plate 261 and a dimming plate (not illustrated). The right light guide plate 261 is made of a light-transmitting resin material or the like. The right light guide plate 261 guides image light output from the right display driving unit 22 to the right eye RE of the user while reflecting the light along a light path. The right light guide plate 261 may use a diffraction grating, and may use a transflective film. The dimming plate is a thin plate-shaped optical element, and is disposed so as to cover a surface side of the image display unit 20. The dimming plate protects the right light guide plate 261 so as to prevent the right light guide plate 261 from being damaged, polluted, or the like. In addition, light transmittance of the dimming plate is adjusted so as to adjust an amount of external light entering the eyes of the user, thereby controlling an extent of visually recognizing a virtual image. Further, the dimming plate may be omitted.

The left optical image display unit 28 has the substantially same configuration as that of the right optical image display unit 26, and operates in the same manner as the right optical image display unit 26. In other words, the left optical image display unit 28 includes a left light guide plate 262 and a dimming plate (not illustrated), and guides image light output from the left display driving unit 24 to the left eye LE of the user. Detailed description thereof will be omitted.

The nine-axis sensor 66 is a motion sensor which detects acceleration (in three axes), angular velocity (in three axes), and geomagnetism (in three axes). The nine-axis sensor 66 is provided in the image display unit 20, and thus functions as a motion detection unit which detects a motion of the head of the user of the head mounted display 100 when the image display unit 20 is mounted on the head of the user. Here, the motion of the head includes velocity, acceleration, angular velocity, a direction, and changing in a direction.

FIG. 4 is a diagram illustrating an example of a virtual image which is visually recognized by the user. FIG. 4 exemplifies a view field VR of the user. As mentioned above, the image light which is guided to both eyes of the user of the head mounted display 100 forms an image on the retinas of the user, and thus the user can visually recognize a virtual image VI. In the example of FIG. 4, the virtual image VI is a standby screen of the OS of the head mounted display 100. In addition, the user visually recognizes external scenery SC through the right optical image display unit 26 and the left optical image display unit 28. As mentioned above, the user of the head mounted display 100 of the present embodiment can view the virtual image VI and the external scenery SC which is a background of the virtual image VI, in a part of the view field VR where the virtual image VI is displayed. Further, the user can directly view the external scenery SC through the right optical image display unit 26 and the left optical image display unit 28 in a part of the view field VR where the virtual image VI is not displayed. Furthermore, in the present specification, “displaying an image on the head mounted display 100” also includes allowing a user of the head mounted display 100 to visually recognize a virtual image.

### A-3. Arrangement Process

FIG. 5 is a sequence diagram illustrating a procedure of an arrangement process. The arrangement process is a process of generating a list image in which an image of the head mounted display 100 and a display image of the smart phone 300 are arranged side by side, and displaying the generated list image on the head mounted display 100. The arrangement process is mainly performed by the generation unit 142.

In step S100, an application for performing the arrangement process is activated. The activation of the application in step S100 may be triggered by the input information acquisition unit 110 detecting an activation operation performed by the user, and may be triggered by detecting an activation command from another application. Due to the activation of the application in step S100, functions of the generation unit 142 and the notification unit 144 are implemented by the CPU 140.

In step S102, the wireless communication unit 132 or the interface 180 detects connection of the smart phone 300. In addition, hereinafter, as an example, description will be made of a case where the head mounted display 100 and the smart phone 300 perform communication by using a wireless LAN conforming to IEEE 802.11. In step S104, the generation unit 142 performs authentication of the smart phone 300 which is connected thereto via the wireless communication unit 132. The authentication may be performed by using various authentication techniques. For example, the generation unit 142 may authenticate the smart phone 300 by using a media access control (MAC) address of the smart phone 300, and may authenticate the smart phone 300 by using a user name and a password. Further, the generation unit 142 may authenticate the smart phone 300 by using a digital certificate which is issued by an authentication station, and may authenticate the smart phone 300 by recognizing a physical feature (a face, a fingerprint, or a voiceprint) of a user. After the authentication in step S104 is successful, the generation unit 142 establishes connection to the smart phone 300 in step S106.

In step S108, the smart phone 300 acquires a display image of the smart phone 300. Specifically, the smart phone 300 performs rendering on a screen which is currently displayed in the smart phone 300, such as content which is currently reproduced in the smart phone 300 or an application graphical user interface (GUI), in accordance with a predetermined standard, so as to acquire a frame image. The frame image acquired in step S108 is a display image of the smart phone 300 and is hereinafter also referred to as a “first image”.

In step S110, the smart phone 300 transmits the acquired first image to the head mounted display 100. The generation unit 142 of the head mounted display 100 acquires the first image via the wireless communication unit 132. At this time, the generation unit 142 and the wireless communication unit 132 function as an “acquisition unit”.

In step S112, the generation unit 142 acquires an image which is currently displayed on a display screen of the head mounted display 100 as an image of the head mounted display 100. Specifically, the generation unit 142 acquires a frame image by using the same method as the method in step S108. In addition, the generation unit 142 may directly acquire a frame image from the image processing unit 160 or a video memory. The frame image acquired in step S112 is an image of the head mounted display 100, and is hereinafter also referred to as a “second image”.

In step S114, the generation unit 142 enlarges or reduces the first image and the second image. Specifically, the generation unit 142 enlarges or reduces the first image acquired in step S110 so as to match a size of the first region AR1 of the region information AI (FIG. 3). Similarly, the generation unit 142 enlarges or reduces the second image acquired in step S112 so as to match a size of the second region AR2 of the region information AI. In addition, the generation unit 142 preferably performs the enlargement or reduction in a state of maintaining each of aspect ratios of the first image and the second image. Then, the generation unit 142 can generate a list image which faithfully reproduces a display image of the smart phone 300 and an image (display image) of the head mounted display 100.

In step S115, the generation unit 142 disposes the first image in the first region AR1 of the region information AI, and disposes the second image in the second region AR2 of the region information AI, so as to generate a list image. At this time, the generation unit 142 may perform processings as exemplified in the following a1 to a5 on at least of the first image and the second image. In addition, the processings a1 to a5 may be employed singly, and may be employed together.

(a1) The generation unit 142 changes shapes of the first and second images. For example, the generation unit 142 may change rectangular first and second images to a circular or trapezoidal images.

(a2) The generation unit 142 changes transmittance of the first and second images. If the transmittance of the first and second images is changed, it is possible to prevent a view field of a user from being impeded by a list image when the user visually recognizes the list image which is displayed as a virtual image.

(a3) The generation unit 142 performs a color conversion process on the first and second images. For example, the image display unit 20 is provided with a camera which captures an image of external scenery in a visual line direction of a user and acquires the external scenery image. In addition, the generation unit 142 performs a color conversion process for strengthening or weakening a complementary color of the external scenery image, on the first and second images. In this way, the generation unit 142 can make the first and second images more visible than the external scenery.

(a4) The generation unit 142 changes sizes of the first and second images. For example, the generation unit 142 enlarges or reduces the first and second images regardless of sizes of the first and second regions of the region information AI.

(a5) The generation unit 142 adds decorations such as text, graphics, and symbols to the first and second images. For example, the generation unit 142 may add text for explaining an image to the first and second images. In addition, for example, the generation unit 142 may add a frame which borders a circumference of an image, to the first and second images.

As mentioned above, by performing the processings as in the above a1 to a5 on one of the first image and the second image, a user who visually recognizes the list image easily differentiates the first image from the second image in the list image. In addition, even if the processings as in the above a1 to a5 are performed on both the first image and the second image by using other aspects, it is possible to improve differentiation between images in the user in the same manner.

In step S118, the generation unit 142 displays the list image on the head mounted display 100. Specifically, the generation unit 142 transmits the list image generated in step S116 to the image processing unit 160. The image processing unit 160 which has received the list image performs the above-described display process. As a result, the image light guided to both eyes of the head mounted display 100 forms an image on the retinas of the user, and thus the user of the head mounted display 100 can visually recognize a virtual image of the list image in a view field. In other words, the head mounted display 100 can display the list image.

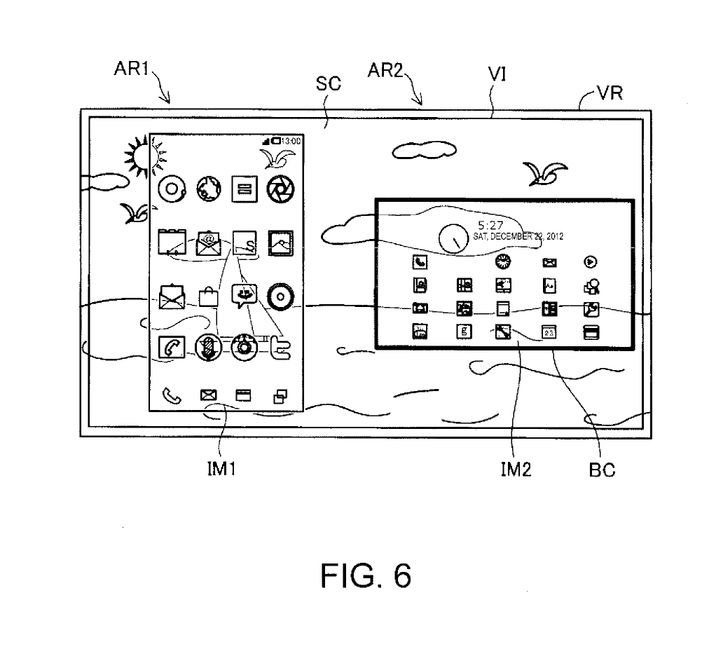

FIG. 6 is a diagram illustrating a state in which a list image is displayed on the head mounted display 100. As illustrated in FIG. 6, the user of the head mounted display 100 can visually recognize a list image in which a first image IM1 is disposed in the first region AR1 of the region information AI (FIG. 3), and a second image IM2 is disposed in the second region AR2, as a virtual image VI in a view field VR. In addition, a decoration using a thick frame BC is added to the second image IM2. For this reason, the user can easily differentiate the first image from the second image.

In addition, in a case where the arrangement process of FIG. 5 is applied to a moving image, the above steps S108 to S118 are repeatedly performed. Further, in a case where a standard for compressing a moving image is used, a difference image (a difference between frames) indicating a part which varies from an original image or a frame image may be transmitted in step S108. In this case, the generation unit 142 may perform a process of synthesizing a frame image by using a previous frame image and an acquired difference between frames, between steps S110 and S112.

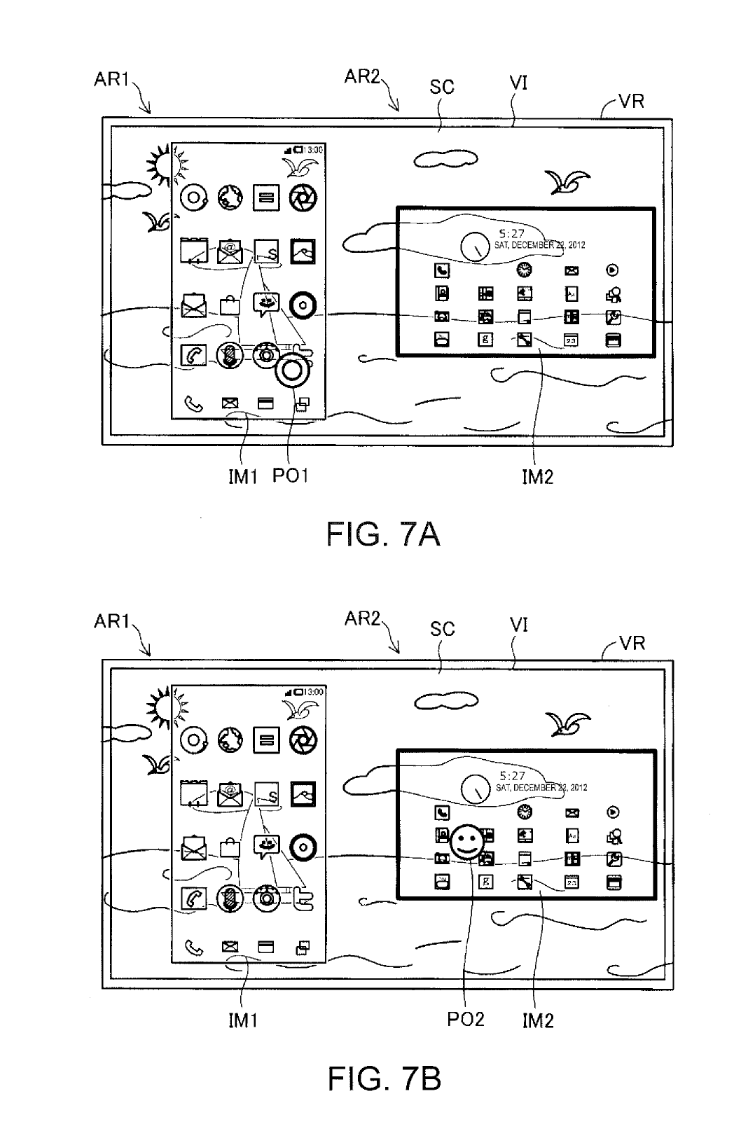

FIGS. 7A and 7B are diagrams illustrating a variation in a pointer image of a list image. FIG. 7A illustrates a pointer image PO1 which is superimposed on the first image IM1. In an example of FIG. 7A, the pointer image PO1 is a graphic indicating a double circle. FIG. 7B illustrates a pointer image PO2 which is superimposed on the second image IM2. In an example of FIG. 7B, the pointer image PO2 is a graphic in which a circular smiling face is drawn. As described above, in step S118 of the arrangement process (FIG. 5), the generation unit 142 transmits the list image to the image processing unit 160 via the OS 150. At this time, the OS 150 superimposes and draws a pointer image on the list image in response to a user's operation acquired from the input information acquisition unit 110. The generation unit 142 instructs the OS 150 to make a pointer image which is superimposed and drawn on the first image IM1 of the list image different from a pointer image which is superimposed and drawn on the second image IM2.

As a result, as illustrated in FIGS. 7A and 7B, the image display unit can allow the user to visually recognize the pointer image PO1 superimposed on the first image IM1 of the list image and the pointer image PO2 superimposed on the second image IM2 as different virtual images VI. In this way, the user of the head mounted display 100 easily differentiates whether an operation target of the user in the list image is the smart phone 300 (external apparatus) indicated by the first image IM1 or the head mounted display 100 indicated by the second image IM2.

In addition, the generation unit 142 may transmit an instruction for changing a shape of at least one of the pointer images PO1 and PO2 instead of the instruction described in FIGS. 7A and 7B or along with the instruction described in FIGS. 7A and 7B, to the OS 150, so as to draw the pointer image PO1 superimposed on the first image IM1 of the list image and the pointer image PO2 superimposed on the second image IM2 as different images. Further, the generation unit 142 may performs an instruction for change of transmittance, a color conversion process, change of a size, addition of decorations of text, graphics, or symbols, and the like, instead of the above-described “change of a shape”. In this way, the user of the head mounted display 100 easily differentiates the pointer images PO1 and PO2 displayed in the list image from each other.

As mentioned above, according to the arrangement process of the first embodiment, the image display unit 20 can generate the virtual image VI indicating a list image (FIG. 6) including the first image which is a display image of the smart phone 300 (external apparatus) connected to the head mounted display 100 and the second image which is an image of the head mounted display 100, and allows the user to visually recognize the virtual image. Therefore, it is possible to provide the head mounted display 100 which allows a user to visually recognize both a display image of the head mounted display 100 and a display image of the smart phone 300.

In addition, according to the arrangement process of the first embodiment, the generation unit 142 can easily generate a list image by disposing the first image acquired from the smart phone 300 (external apparatus) in the first region AR1 and disposing the second image of the head mounted display 100 in the second region AR2 on the basis of the region information AI (FIG. 3).

Further, according to the arrangement process of the first embodiment, the generation unit 142 can generate a list image by acquiring a frame image (display image) which is currently displayed on a display screen of the head mounted display 100 as an image of the head mounted display 100 and using the acquired display image as the second image without change. For this reason, it is possible to make process content of the arrangement process in the generation unit concise.

### A-4. Notification Process

FIG. 8 is a sequence diagram illustrating a procedure of a notification process. The notification process is a process of notifying the smart phone 300 or the head mounted display 100 of operation content when an operation is performed on the first and second images in the list image. The notification process is mainly performed by the notification unit 144. In addition, at this time, the notification unit 144 functions as a “first notification unit”.

In step S200, the input information acquisition unit 110 detects a user's operation (for example, click, double click, drag, on-focus, tap, double tap, or flick) on the list image, and acquires a coordinate (x, y) related to the operation. At this time, the input information acquisition unit 110 functions as an “operation acquisition unit”.

In step S202, the notification unit 144 receives the coordinate (x, y) from the input information acquisition unit 110, and executes the following procedures i and ii.

(1) Whether an operated image is the first image or the second image is specified on the basis of the received coordinate.

(ii) A coordinate is obtained in the image which does not undergo the enlargement or reduction in step S114 of the arrangement process (FIG. 5) on the basis of the received coordinate.

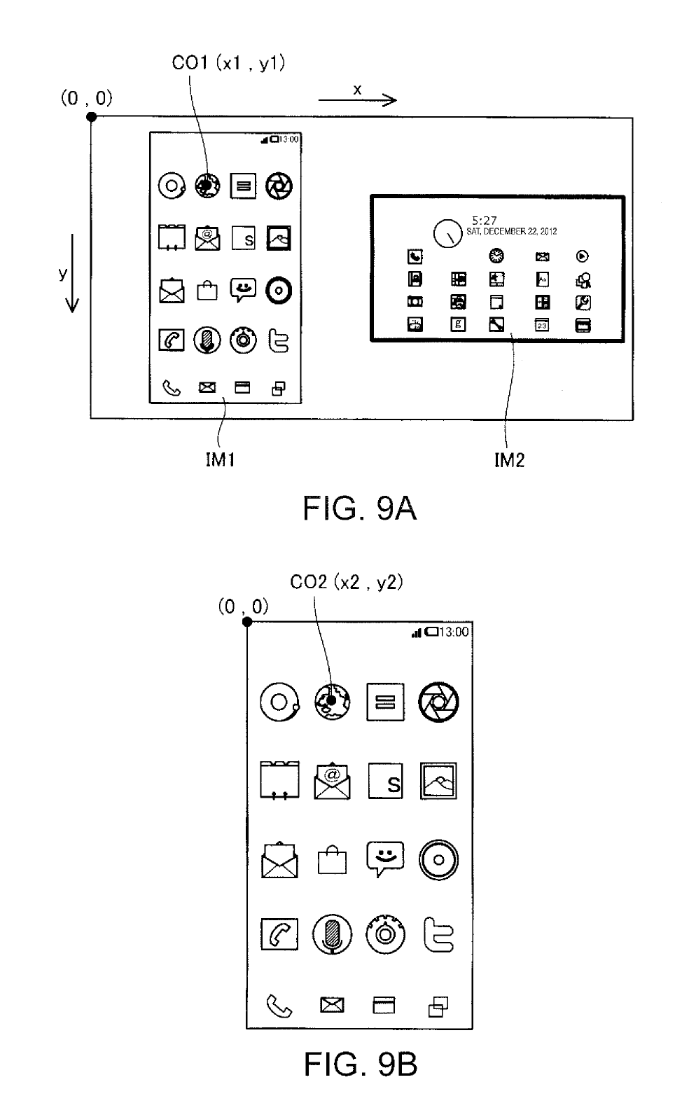

FIGS. 9A and 9B are diagrams illustrating step S202 of the notification process. FIG. 9A is a diagram illustrating the procedure i. In step S202 of the notification process, the notification unit 144 receives a coordinate CO1 (x1,y1) from the input information acquisition unit 110. The coordinate CO1 is a numerical value indicating a variation in the x direction and a variation in the y direction when a coordinate of the upper left end of the list image is set to (0,0). The notification unit 144 specifies whether the coordinate CO1 (x1,y1) is located on the first image IM1 or the second image IM2 on the basis of the process content in step S115 of the arrangement process (FIG. 5). In an example of FIG. 9A, the coordinate CO1 (x1,y1) is located on the first image IM1, that is, on the display image of the smart phone 300.

FIG. 9B is a diagram illustrating the procedure ii. The notification unit 144 performs conversion reverse to the conversion which has been performed in step S114 on the list image by using the enlargement or reduction rate used in step S114 of the arrangement process (FIG. 5). In other words, in a case where reduction has been performed in step S114, the list image is enlarged, and in a case where enlargement has been performed in step S114, the list image is reduced. Then, the notification unit 144 obtains a coordinate CO2 (x2,y2) corresponding to the same position as the coordinate CO1 (x1, y1) when a coordinate of an upper left end of an image (that is, the first image IM1 or the second image IM2) specified in FIG. 9A is set to (0,0).

In step S204, the notification unit 144 determines whether or not the image specified in step S202 is the second image, that is, an image (display image) of the head mounted display 100. If the image is the second image, the notification unit 144 transmits the coordinate CO2 (x2,y2) and operation content (for example, click, double click, drag, on-focus, tap, double tap, or flick) to the OS 150. The OS 150 performs a process such as activation of an application on the basis of the received coordinate and operation content.

In step S206, the notification unit 144 determines whether or not the image specified in step S202 is the first image, that is, a display image of the smart phone 300. If the image is the first image, the notification unit 144 transmits the coordinate CO2 (x2,y2) and operation content to the smart phone 300. The smart phone 300 performs a process such as activation of an application on the basis of the received coordinate and operation content (step S208).

As mentioned above, according to the notification process of the first embodiment, the notification unit 144 (first notification unit) cannot only notify the OS 150 of a user's operation on the second image IM2 (FIG. 9A) of the list image, but can also notify the smart phone 300 (external apparatus) of a user's operation on the first image IM1 (FIG. 9A). For this reason, the user cannot only operate the head mounted display 100 by using the input interface of the head mounted display 100 but can also remotely operate the smart phone 300 by using the input interface of the head mounted display 100. As a result, for example, the user can operate an external apparatus in a state of putting the external apparatus (the smart phone 300 in the present embodiment) connected to the head mounted display 100 into a bag or a pocket, and thus it is possible to improve usability of the head mounted display 100.

### B. Second Embodiment

In a second embodiment of the invention, description will be made of a configuration in which a second image generated from an icon image is used as an “image of a head mounted display”. Hereinafter, only constituent elements having configurations and operations different from those of the first embodiment will be described. In addition, in the drawings, constituent elements which are the same as those of the first embodiment are given the same reference numerals as in the above-described first embodiment, and detailed description will be omitted.

### B-1. Configuration of Image Display System

A schematic configuration of an image display system of the second embodiment is the same as that of the first embodiment illustrated in FIG. 1.

### B-2. Configuration of Head Mounted Display

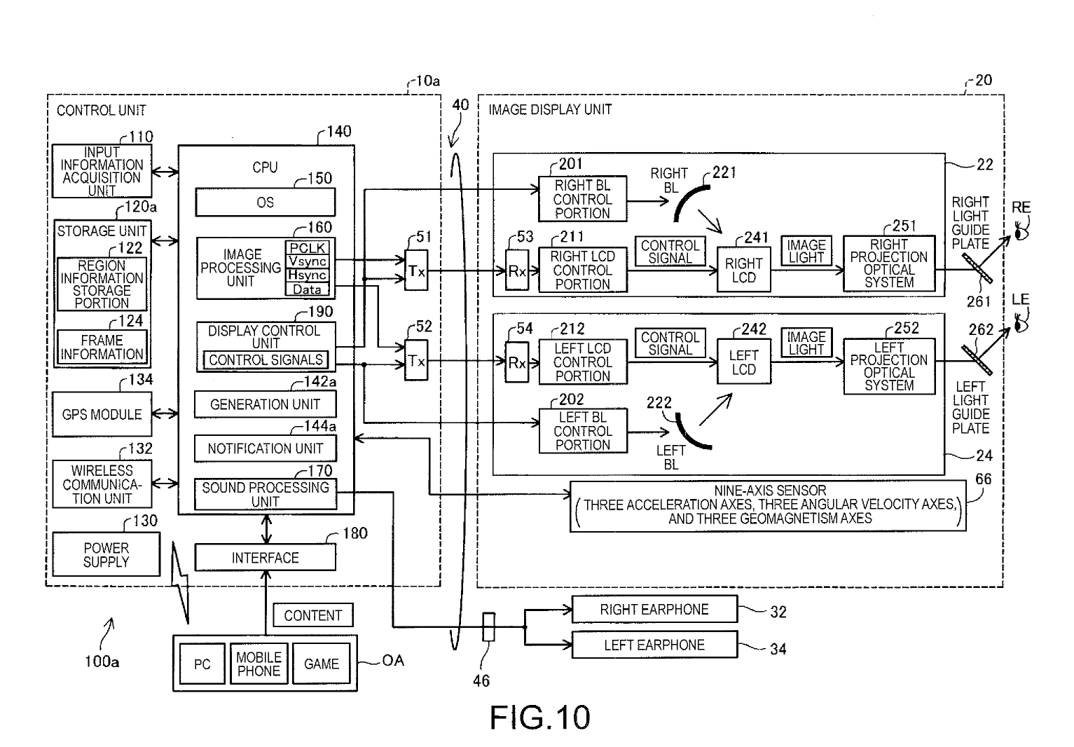

FIG. 10 is a functional block diagram illustrating a configuration of a head mounted display 100a of the second embodiment. A difference from the first embodiment illustrated in FIG. 2 is that a control unit 10a is provided instead of the control unit 10. The control unit 10a includes a generation unit 142a instead of the generation unit 142, a notification unit 144a instead of the notification unit 144, and a storage unit 120a instead of the storage unit 120.

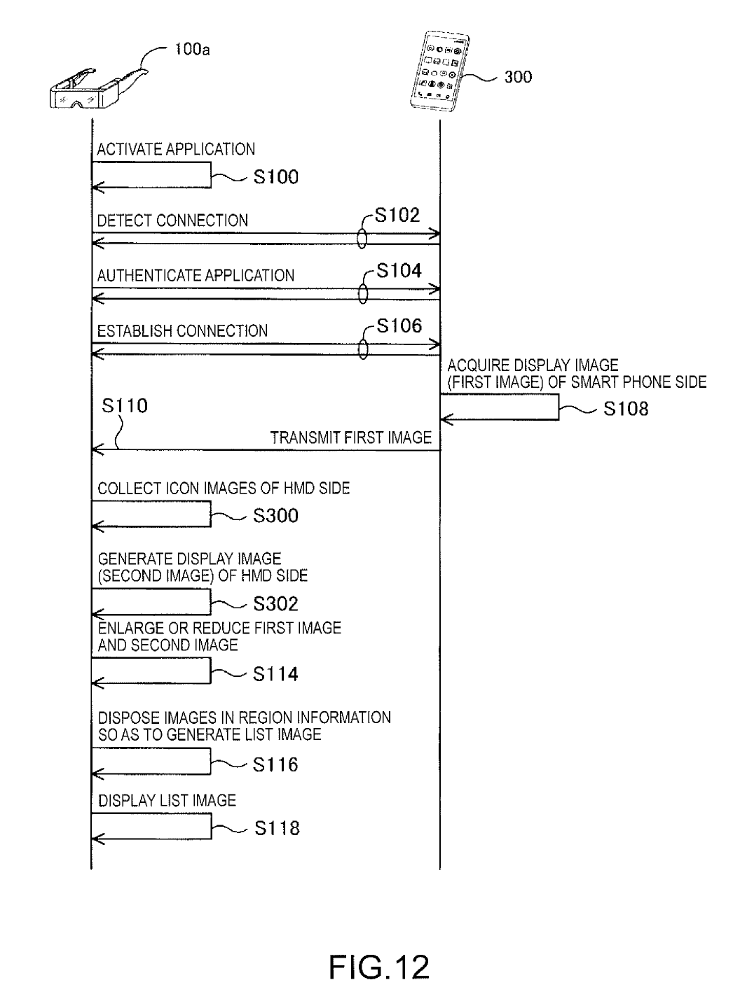

In the generation unit 142a, process content of an arrangement process is different from that of the first embodiment described with reference to FIG. 5. In the notification unit 144a, process content of a notification process is different from that of the first embodiment described with reference to FIG. 8. The storage unit 120a includes frame information 124 in addition to the region information storage portion 122. The frame information 124 stores at least one frame. A frame stored in the frame information 124 is used as a frame for disposing an icon image when a second image (that is, an image generated by changing an arrangement of the icon image of the head mounted display 100a) is generated in an arrangement process (FIG. 12) of the second embodiment.

In the present embodiment, the “icon image” indicates an image which comprehensively represents content of a program or a device by using a drawing, a picture, text, a symbol, or the like. The “icon image” of the present embodiment indicates an image for activating an application which is installed in the head mounted display 100a. In addition, the “icon image” may include an image drawn by an application (so-called widget or gadget) which is installed in the head mounted display 100a, an image for activating data (various files) stored in the head mounted display 100a, an image indicating the presence of a device included in the head mounted display 100a, or the like. In other words, it can be said that the icon image is a symbol abstracted from an application (program), data, or a device.

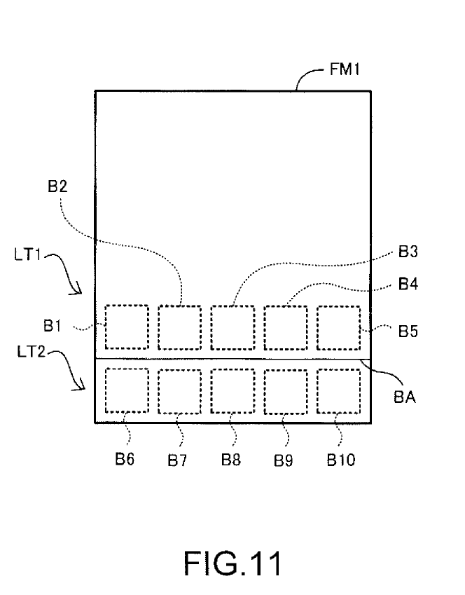

FIG. 11 is a diagram illustrating an example of a frame stored in the frame information 124. A frame FM1 illustrated in FIG. 11 has a configuration in which an image list LT1, an image list LT2, and a partition line BA for partitioning the lists are disposed inside a rectangular region (hereinafter, also referred to as a “region of the frame FM1”). The region of the frame FM1 preferably has the same aspect ratio as that of the second region AR2 of the region information AI.

The image lists LT1 and LT2 are regions in which icon images are disposed in practice in an arrangement process of the second embodiment. In the example of FIG. 11, the image lists LT1 and LT2 are disposed in two stages over the entire lower end of the region of the frame FM1. In addition, the image lists LT1 and LT2 may be disposed at any location of the frame FM1. For example, the image lists LT1 and LT2 may be disposed at a part of the lower end of the region of the frame FM1, may be disposed at a part of or the entire upper end of the region of the frame FM1, may be disposed at a part of or the entire right end of the region of the frame FM1 may be disposed at a part of or the entire left end of the region of the frame FM1, and may be disposed in the entire region of the frame FM1.

The image list LT1 includes a plurality of (five frames in the illustrated example) rectangular image frames B1 to B5. The image frames E1 to B5 are disposed so that long sides of the rectangular shapes are adjacent to each other in the image list LT1. The image list LT2 includes a plurality of rectangular image frames B6 to B0. The image frames B6 to B10 are disposed so that long sides of the rectangular shapes are adjacent to each other in the image list LT2. The image frames B1 to B10 are regions in which icon images of the head mounted display 100a are disposed in the arrangement process (FIG. 12) of the second embodiment.

### B-3. Arrangement Process

FIG. 12 is a sequence diagram illustrating a procedure of the arrangement process of the second embodiment. Only a difference from the first embodiment illustrated in FIG. 5 is that step S300 and step S302 are provided instead of step S112, and other process content items are the same as those of the first embodiment.

In step S300, the generation unit 142a collects icon images of the head mounted display 100a. Specifically, the generation unit 142a collects a plurality of icon images which is to be displayed on a standby screen of the head mounted display 100a from among a plurality of icon images stored in a predetermined region of the storage unit 120. Examples of the icon images include icons for activating various devices such as a camera and a speaker, and various services such as an SNS service and a mail service.

Instep S302, the generation unit 142 generates the second image by changing an arrangement of the plurality of icon images collected in step S300. Specifically, the generation unit 142a acquires the frame FM1 (FIG. 11) stored in the frame information 124. The generation unit 142a sequentially disposes the plurality of acquired icon images at the image frames B1 to B5 of the image list LT1 and the image frames B6 to B10 of the image list LT2.

In addition, the generation unit 142a may perform the following processes b1 to b3 between step S300 and step S302.

b1. Filtering Process of Icon Image
For example, the generation unit 142 may obtain duplicate icon images from the icon images collected in step S300, by using image analysis or file name analysis, and may discard one of the duplicate icon images.
For example, the generation unit 142a may specify an application indicated by an icon image from the icon images collected in step S300, by using image analysis or file name analysis, and may discard an icon image regarding a predetermined application.
For example, the generation unit 142a may obtain the frequency of use for an application indicated by an icon image by referring to information associated with the icon images collected in step S300, and may discard a less frequently used icon image.
   b2. Grouping and Sorting of Icon Images
For example, the generation unit 142a may specify the kind of icon image (an image for activating an application, an image drawn by an application, or an image for activating data) from the icon images collected in step S300 by using image analysis or file name analysis, and may group or sort icon images depending on the specified kind of icon image.
For example, the generation unit 142a may specify the kind or the name of application from the icon images collected in step S300 by using image analysis or file name analysis, and may group or sort icon images depending on the specified kind or name of application.
For example, the generation unit 142a may obtain the frequency of use for an application indicated by an icon image by referring to information associated with the icon images collected in step S300, and may group or sort icon images depending on the frequency in use.
   b3. Processing of Icon Image
For example, the generation unit 142a may arbitrarily change a shape, transmittance, or a size of an icon image.
For example, the generation unit 142a may perform a color conversion process on an icon image. In this case, the image display unit 20 is provided with a camera which captures an image of external scenery in a visual line direction of a user and acquires the external scenery image. In addition, the generation unit 142a performs a color conversion process for strengthening a complementary color of the external scenery image, on the icon image. Accordingly, the generation unit 142a can make the icon image more visible than the external scenery.
For example, the generation unit 142a adds decorations such as text, graphics, and symbols to an icon image. Specifically, the generation unit 142a may add text for explaining an icon image to the icon images. Accordingly, when the second image displayed as a virtual image is visually recognized, a user easily understands what each icon image included in the second image is. In addition, the generation unit 142a may add a frame which borders a circumference of an icon image, to the icon image. Accordingly, the generation unit 142a can make the icon image more visible than the external scenery.

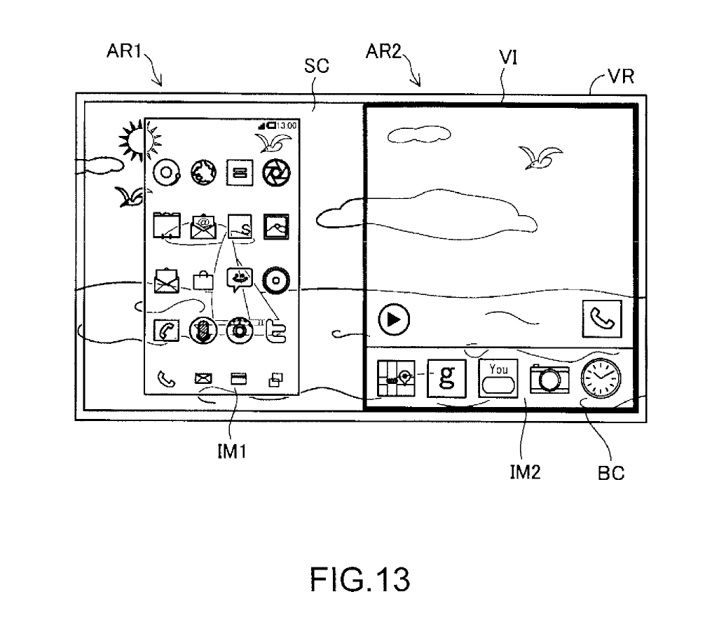

FIG. 13 is a diagram illustrating a state in which a list image is displayed on the head mounted display 100a. As illustrated in FIG. 13, a user of the head mounted display 100a of the second embodiment can visually recognize a list image in which the first image IM1 is disposed in the first region AR1 of the region information AI (FIG. 3), and the second image IM2 generated by using an icon image of the head mounted display 100a is disposed in the second region AR2, as the virtual image in the view field VR.

In addition, in a case where the arrangement process of FIG. 12 is applied to a moving image, the above steps S108 to S118 are repeatedly performed in the same manner as in the first embodiment. Further, a variation in a pointer image in the list image is also the same as in the first embodiment.

As mentioned above, according to the arrangement process of the second embodiment, the generation unit 142a can generate the second image IM2 whose aspect ratio is freely changed according to the frame FM1 by changing an arrangement of icon images of the head mounted display 100a, and can generate a list image by using the generated second image IM2. As a result, the generation unit 142a can generate the optimal second image according to a size of the second region AR2 of the region information AI (FIG. 3), and can generate the second image on the image display unit 20.

### B-4. Notification Process

A notification process of the second embodiment is substantially the same as that of the first embodiment illustrated in FIG. 8. However, in a case where the image specified in the procedure i of step S202 is the second image, the procedure ii is replaced with the following procedure iii.

(iii) The notification unit 144a obtains a coordinate CO2 (x2,y2) corresponding to the coordinate CO1 (x1,y1) acquired from the input information acquisition unit 110, on the basis of process content (that is, arrangement of icon images) in step S302 of the arrangement process (FIG. 12).

### C. Third Embodiment

In a third embodiment of the invention, description will be made of a configuration in which one head mounted display is connected to a plurality of other head mounted displays as external apparatuses, and display of a pointer in one head mounted display is shared by the external apparatuses. Hereinafter, only configurations and operations different from those of the first embodiment. In addition, in the drawings, constituent elements which are the same as those of the first embodiment are given the same reference numerals as in the above-described first embodiment, and detailed description will be omitted.

### C-1. Configuration of Image Display System

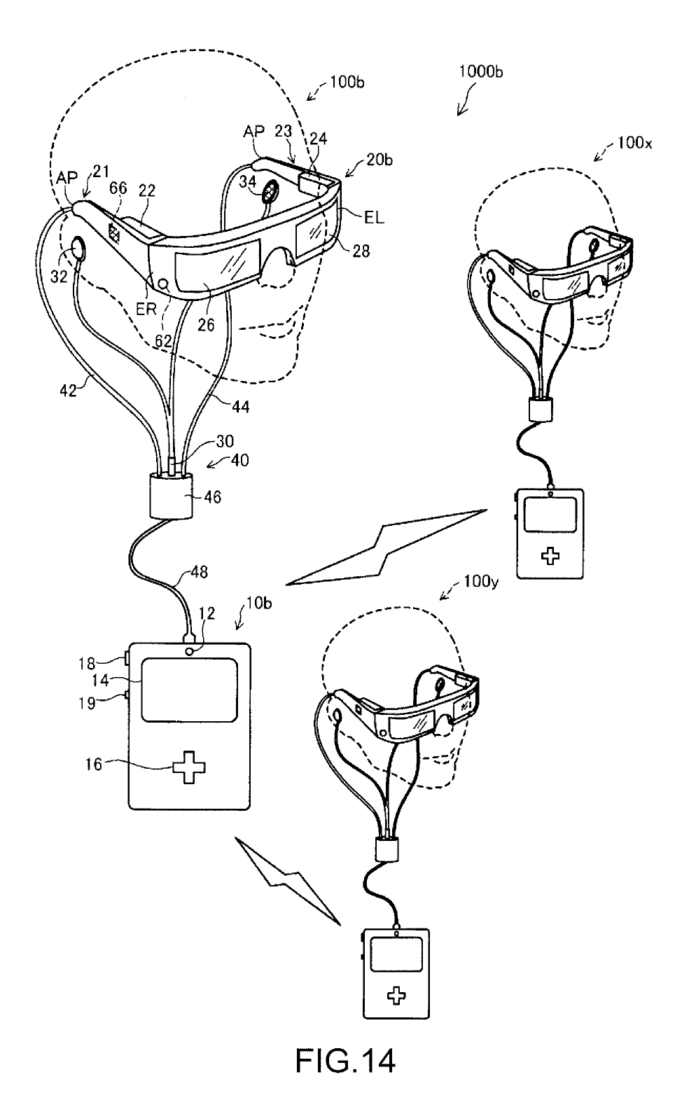

FIG. 14 is a diagram illustrating a schematic configuration of an image display system 1000b of the third embodiment. A difference from the first embodiment illustrated in FIG. 1 is that a head mounted display 100b is provided instead of the head mounted display 100, and a head mounted display 100x and a head mounted display 100y are provided instead of the smart phone 300.

The head mounted displays 100b and 100x are connected to each other so as to perform wireless communication or wired communication. Similarly, the head mounted displays 100b and 100y are connected to each other so as to perform wireless communication or wired communication. Configurations of the head mounted displays 100x and 100y are the same as the head mounted display 100b, and thus description thereof will be omitted.

### C-2. Configuration of Head Mounted Display

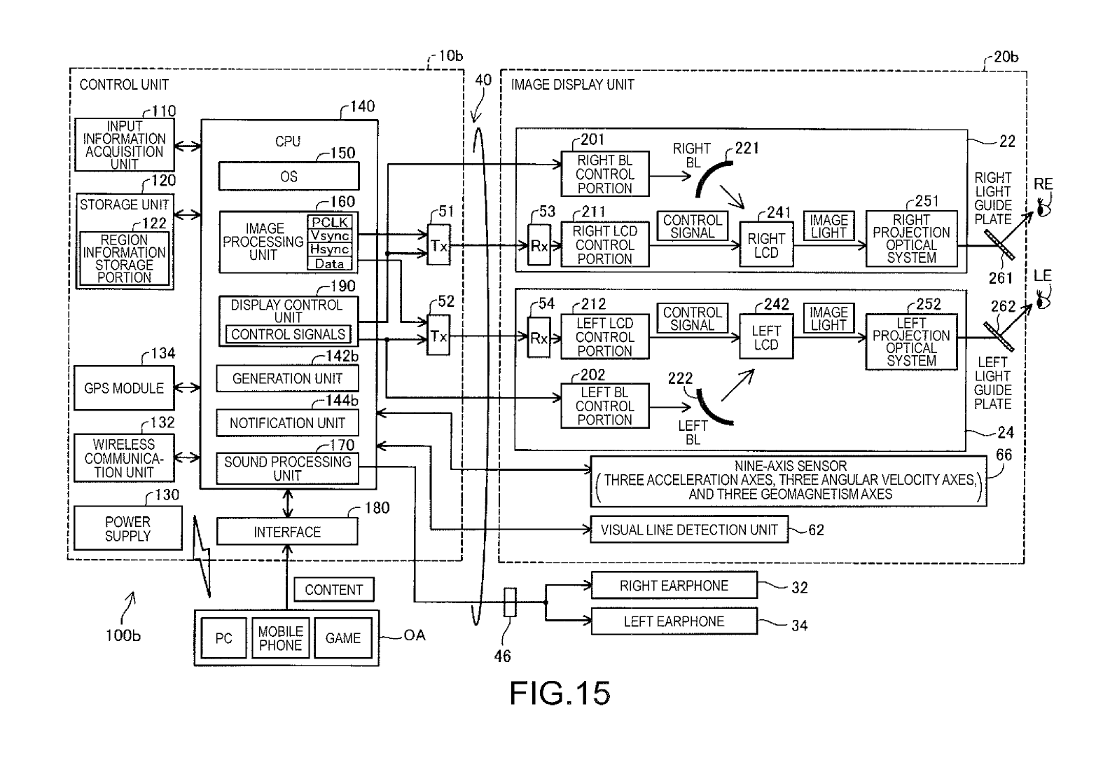

FIG. 15 is a functional block diagram illustrating a configuration of the head mounted display 100b of the third embodiment. A difference from the first embodiment illustrated in FIG. 2 is that a control unit 10b is provided instead of the control unit 10, and an image display unit 20b is provided instead of the image display unit 20.

The control unit 10b includes a generation unit 142b instead of the generation unit 142, and a notification unit 144b instead of the notification unit 144. In the generation unit 142b, process content of an arrangement process is different from that of the first embodiment described with reference to FIG. 5. In the notification unit 144b, process content of a notification process is different from that of the first embodiment described with reference to FIG. 8. In addition, the notification unit 144b performs a pointer notification process described later.

The image display unit 20b further includes a visual line detection unit 62 in addition to the respective units described in the first embodiment. The visual line detection unit 62 is disposed at a position corresponding to the outer corner of the right eye when a user wears the image display unit 20b (FIG. 14). The visual line detection unit 62 is provided with a visible light camera. The visual line detection unit 62 captures images of both eyes of the user by using the visible light camera in a state where the user wears the head mounted display 100b, and detects visual line directions of the user by analyzing the obtained images of the eyes. In addition, the visual line detection unit 62 may employ an infrared sensor instead of the visible light, and may detect visual line directions of the user.

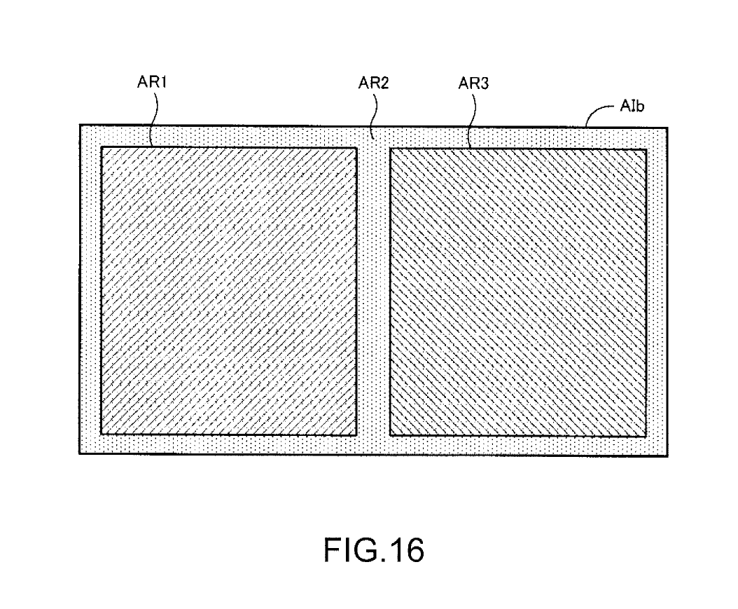

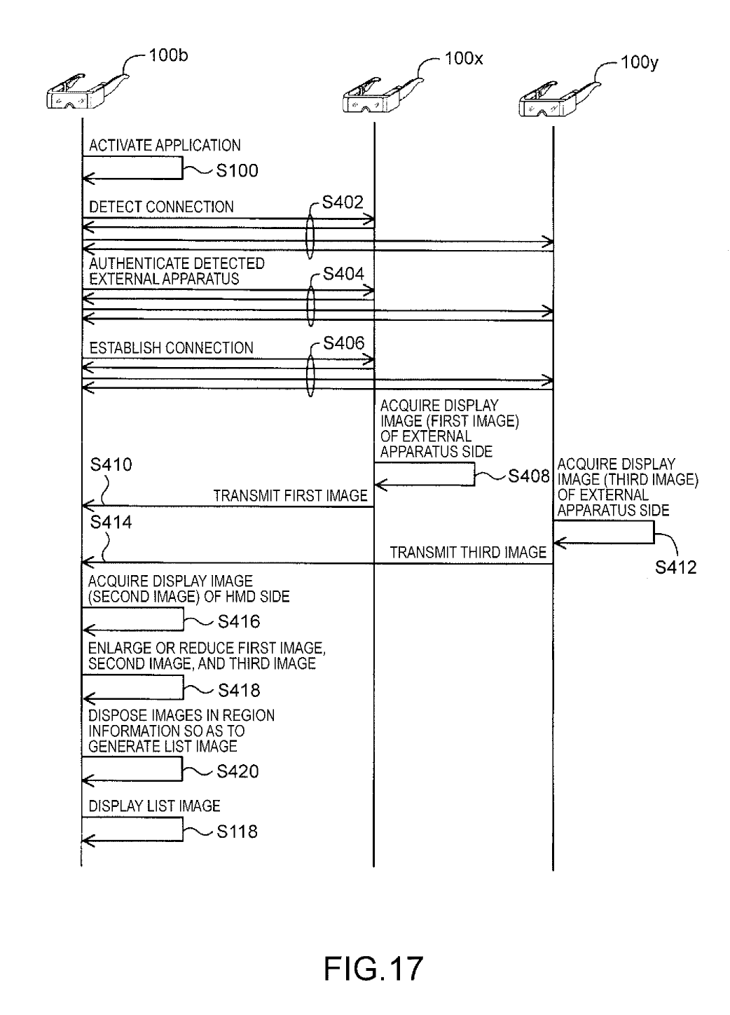

FIG. 16 is a diagram illustrating an example of region information stored in the region information storage portion 122 in the third embodiment. A difference from the first embodiment illustrated in FIG. 3 is that a rectangular region An includes a third region AR3 in addition to the first region AR1 and the second region AR2, and further an arrangement of the respective regions is different from that of the first embodiment. The first region AR1 is a region in which a display image of the head mounted display 100x is disposed in an arrangement process (FIG. 17). The second region AR2 is a region in which a display image of the head mounted display 100b is disposed in the arrangement process. The third region AR3 is a region in which a display image of the head mounted display 100y is disposed in the arrangement process.

The second region AR2 is disposed over the entire region AIb. The first region AR1 and the third region AR3 are respectively disposed at approximately central parts of left and right sides into which the region AIb is equally divided. A length of each of the first and third regions AR1 and AR3 in the vertical direction is smaller than a length of the second region AR2 in the vertical direction. A length of each of the first and third regions AR1 and AR3 in the horizontal direction is smaller than a length obtained by dividing a length of the second region AR2 in the horizontal direction by 2. In addition, the first and third regions AR1 and AR3 are superimposed on the second region AR2 as a layer.

### C-3. Arrangement Process

FIG. 17 is a sequence diagram illustrating a procedure of the arrangement process of the third embodiment. A difference form the first embodiment illustrated in FIG. 5 is that steps S402 to S420 are provided instead of steps S102 to S116.

In step S402, the wireless communication unit 132 of the head mounted display 100b detects connection of the head mounted display 100x, and detects connection of the head mounted display 100y. Details thereof are the same as those of step S102 of FIG. 5. In step S404, the generation unit 142b of the head mounted display 100b performs authentication of the connected head mounted display 100x, and performs authentication of the head mounted display 100y. Details thereof are the same as those of step S104 of FIG. 5. After the authentication is successful, in step S406, the generation unit 142b establishes connection between the head mounted displays 100b and 100x, and establishes connection between the head mounted displays 100b and 100y.

In step S408, the head mounted display 100x acquires a display image of the head mounted display 100x. Details thereof are the same as those of step S108 of FIG. 5. The frame image acquired in step S408 is a display image of the head mounted display 100x as an external apparatus, and is hereinafter also referred to as a “first image”. In step S410, the head mounted display 100x transmits the acquired first image to the head mounted display 100b. Details thereof are the same as those of step S110 of FIG. 5.

In step S412, the head mounted display 100y acquires a display image of the head mounted display 100y. Details thereof are the same as those of step S108 of FIG. 5. The frame image acquired in step S412 is a display image of the head mounted display 100y as an external apparatus, and is hereinafter also referred to as a “third image”. In step S414, the head mounted display 100y transmits the acquired third image to the head mounted display 100b. Details thereof are the same as those of step S110 of FIG. 5.

In step S416, the generation unit 142b of the head mounted display 100b acquires an image which is currently displayed on a display screen of the head mounted display 100b. Details thereof are the same as those of step S112 of FIG. 5.

In step S418, the generation unit 142b enlarges or reduces the first image, the second image, and the third image. Specifically, the generation unit 142b enlarges or reduces the first image acquired in step S410 so as to match a size of the first region AR1 of the region information AIb (FIG. 16). Similarly, the generation unit 142b enlarges or reduces the second image acquired in step S416 so as to match a size of the second region AR2 of the region information AIb, and enlarges or reduces the third image acquired in step S414 so as to match a size of the third region AR3 of the region information AIb. In addition, in step S418, the generation unit 142b may cut out a part of each of the acquired first to third images IM1 to IM3 in a size matching the first to third regions AR1 to AR3 instead of the enlargement or the reduction.

In step S420, the generation unit 142b disposes the first image in the first region AR1 of the region information AIb, disposes the second image in the second region AR2 of the region information AIb, and disposes the third image in the third region AR3 of the region information AIb, so as to generate a list image. Details thereof are the same as those of step S116 of FIG. 5.

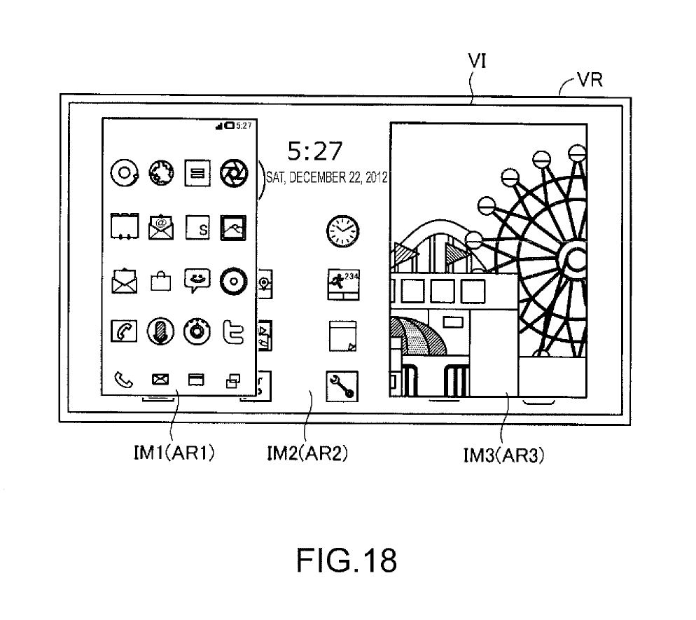

FIG. 18 is a diagram illustrating a state in which a list image is displayed on the head mounted display 100b. In FIG. 18, for convenience of illustration, external scenery SC (FIG. 4) which is visually recognized by a user through the right and left optical image display units 26 and 28 is not illustrated. As illustrated, the user of the head mounted display 100b can visually recognize a list image in which a first image IM1 is disposed in the first region AR1 of the region information AIb (FIG. 16), a second image IM2 is disposed in the second region AR2, and a third image IM3 is disposed in the third region AR3, as a virtual image VI in a view field VR. In addition, in the illustrated example, the first image IM1 is an image of a standby screen of the OS of the head mounted display 100b, the second image IM2 is an image of a standby screen of the OS of the head mounted display 100x, and the third image IM3 is an image captured by a camera of the head mounted display 100y.

In addition, also in the arrangement process (FIG. 17) of the third embodiment, in the same manner as in the first embodiment, the following modifications may occur. Details of each modification are as described in the first embodiment.
Different decorations (frames and the like) are added to the first to third images IM1 to IM3.
The arrangement process of the third embodiment is applied to a moving image.

Pointer images superimposed on the first to third images IM1 to IM3 are made different from each other.

As mentioned above, according to the arrangement process of the third embodiment, even if a plurality of apparatuses are connected as external apparatuses, the same effect as the effect of the arrangement process of the first embodiment can be achieved.

### C-4. Notification Process

In the third embodiment, the notification unit 144b performs a pointer notification process along with a notification process. Here, the pointer notification process is a process for sharing display of a pointer in one head mounted display with external apparatuses. The notification process is a process of notifying an apparatus which is an acquisition source of an image of operation content when an operation is performed on a list image.

### C-4-1. Pointer Notification Process

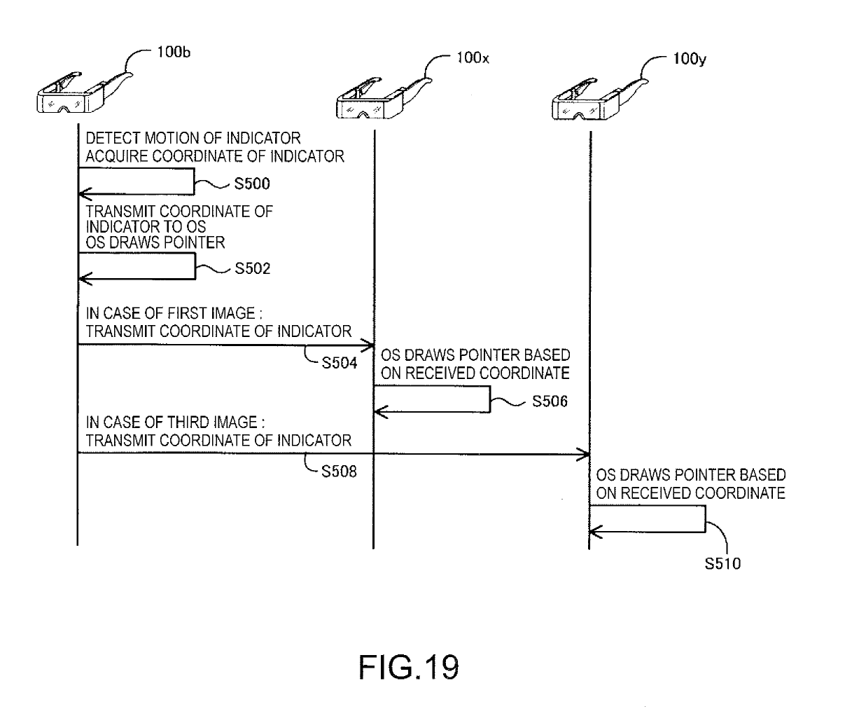

FIG. 19 is a sequence diagram illustrating a procedure of the pointer notification process of the third embodiment. The pointer notification process is mainly performed by the notification unit 144b. In addition, at this time, the notification unit 144b functions as a “second notification unit”. In the present embodiment, the head mounted display 100b is exemplified as one head mounted display, and the head mounted displays 100x and 100y are exemplified as external apparatuses.

In step S500, the input information acquisition unit 110 of the head mounted display 100b detects a motion of an indicator, which is given via an input device of the head mounted display 100b, and acquires a coordinate (x,y) of the indicator on the input device. Here, the “indicator” indicates, for example, the finger of a user or a touch pen. In addition, the input device indicates, for example, a touch pad, a cross key, or a foot switch. At this time, the input information acquisition unit 110 functions as a “position acquisition unit”. In step S502, the notification unit 144b of the head mounted display 100b receives the coordinate of the indicator from the input information acquisition unit 110, and transmits the received coordinate of the indicator to the OS 150. The OS 150 performs a drawing process in which a pointer image is drawn at and is superimposed at a position of the received coordinate of the indicator in a list image.

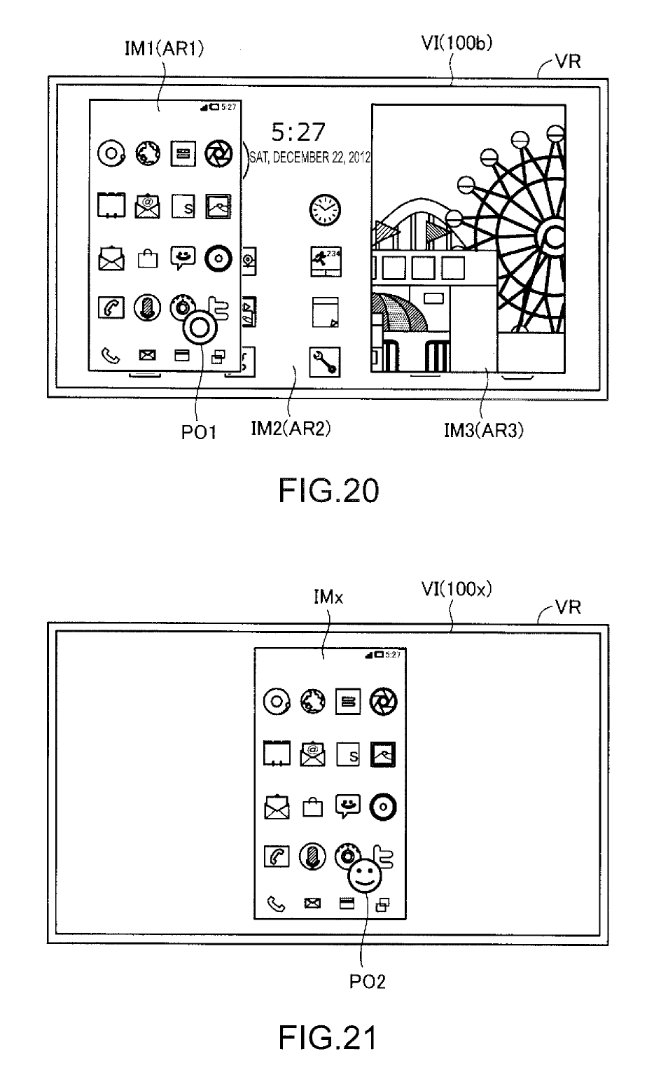

FIG. 20 is a diagram illustrating a state in which a pointer image is superimposed and displayed on a list image in the head mounted display 100b. Also in FIG. 20, in the same manner as in FIG. 18, external scenery SC (FIG. 4) is not illustrated. As illustrated, a user of the head mounted display 100b can visually recognize an image in which a pointer image PO1 is superimposed on the first to third images IM1 to IM3 at a position corresponding to a motion of the user's finger, as a virtual image VI in a view field VR. In an illustrated example, the pointer image PO1 is a graphic indicating a double circle.

In step S504 of FIG. 19, the notification unit 144b of the head mounted display 100b transmits the coordinate of the indicator to an external apparatus which is an acquisition source of the first image, that is, the head mounted display 100x, in a case where the coordinate of the instruction acquired in step S502 is located on the first image. In addition, a method of determining whether or not the coordinate of the indicator is located on the first image is the same as in the procedure i of step S202 of FIG. 8. In addition, in step S504 of FIG. 19, the notification unit 144b transmits the coordinate CO2 (x2,y2) which is converted according to the procedure ii of step S202 of FIG. 8. In step S506, the OS 150 of the head mounted display 100x performs a drawing process in which a pointer image is drawn at and is superimposed at a position of the coordinate of the indicator received in step S504.

FIG. 21 is a diagram illustrating a state in which a pointer image is superimposed and displayed on a list image in the head mounted display 100x as an external apparatus. Also in FIG. 21, in the same manner as in FIG. 18, external scenery SC (FIG. 4) is not illustrated. As illustrated, a user of the head mounted display 100x can visually recognize an image in which a pointer image PO2 is superimposed on an image IMx which is currently displayed on a display screen of the head mounted display 100x at a position corresponding to a motion of the finger of the user of the head mounted display 100b, as a virtual image VI in a view field VR. In an illustrated example, the pointer image PO2 is a graphic in which a circular smiling face is drawn.

In step S508 of FIG. 19, the notification unit 144b of the head mounted display 100b transmits the coordinate of the indicator to an external apparatus which is an acquisition source of the third image, that is, the head mounted display 100y, in a case where the coordinate of the instruction acquired in step S502 is located on the third image. Details thereof are the same as in step S504. In step S510, the OS 150 of the head mounted display 100y performs a drawing process in which a pointer image is drawn and superimposed at a position of the coordinate of the indicator received in step S508. As a result, in the same manner as in FIG. 21, a user of the head mounted display 100y can visually recognize an image in which a pointer image is superimposed on an image which is currently displayed on a display screen of the head mounted display 100y at a position corresponding to a motion of the finger of the user of the head mounted display 100b, as a virtual image.

In addition, in the pointer notification process, a pointer based on a “motion of a visual line” may be displayed instead of the “motion of an indicator” or along with the “motion of an indicator”. In a case of using the “motion of a visual line”, in step S500, the visual line detection unit 62 of the head mounted display 100b acquires a motion of a visual line of the user, and notifies the notification unit 144b of the motion. In subsequent steps, the parts described as the “motion of an indicator” may be replaced with the “motion of a visual line of the user”. In addition, in a case where a pointer based on both a motion of an indicator and a motion of a visual line is displayed, it is preferable that, when both the motion of an indicator and the motion of a visual line are detected, which motion is prioritized is set in advance. Accordingly, the OS 150 of the head mounted display 100b can determine a position of the pointer image PO1 on the basis of at least one of a motion of an indicator on the input device of the head mounted display 100b and a motion of a visual line of a user.

As mentioned above, according to the pointer notification process of the third embodiment, the notification unit 144b (second notification unit) notifies the head mounted display 100x of the coordinate CO2 (positional information) for superimposing the pointer image PO2 for an external apparatus at a position corresponding to a position at which the pointer image PO1 is superimposed on the display image IMx of the head mounted display 100x (external apparatus) in a case where the pointer image PO1 is superimposed on the first image IM1 in the list image. For this reason, the head mounted display 100x can display the pointer image PO2 for an external apparatus on the basis of the acquired coordinate CO2. As a result, the user of the head mounted display 100x can visually recognize the pointer image PO1 on the first image IM1 of the head mounted display 100b, in the head mounted display 100x (FIG. 21). In other words, display of a pointer in the head mounted display 100b can be shared by the head mounted display 100x as an external apparatus.

### C-4-2. Notification Process

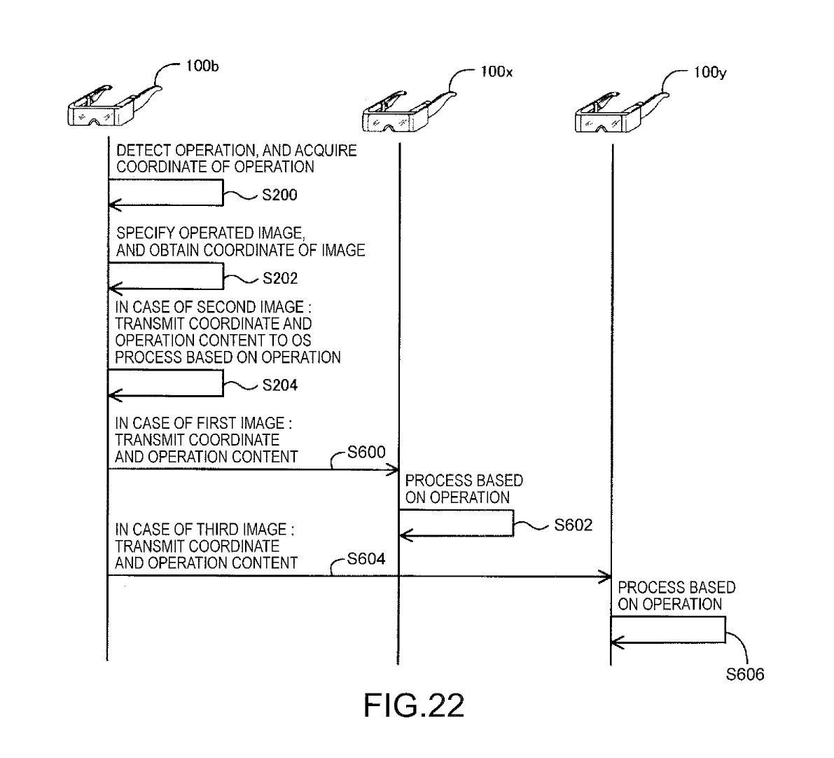

FIG. 22 is a sequence diagram illustrating a procedure of a notification process of the third embodiment. A difference from the first embodiment illustrated in FIG. 8 is that steps S600 to S606 are provided instead of steps S206 and S208. In addition, at this time, the notification unit 144b functions as a “first notification unit”.

In step S600, the notification unit 144b determines whether or not the image specified in step S202 is the first image, that is, a display image of the head mounted display 100x. If the image is the first image, the notification unit 144b transmits a coordinate CO2 (x2,y2) converted according to the procedure ii of step S202 and operation content to the head mounted display 100x. The head mounted display 100x performs a process such as activation of an application or an operation on an application whose activation is in progress on the basis of the received coordinate and operation content (step S602).

In step S604, the notification unit 144b determines whether or not the image specified in step S202 is the third image, that is, a display image of the head mounted display 100y. If the image is the third image, the notification unit 144b transmits a coordinate CO2 (x2,y2) converted according to the procedure ii of step S202 and operation content to the head mounted display 100y. The head mounted display 100y performs a process such as activation of an application or an operation on an application whose activation is in progress on the basis of the received coordinate and operation content (step S606).

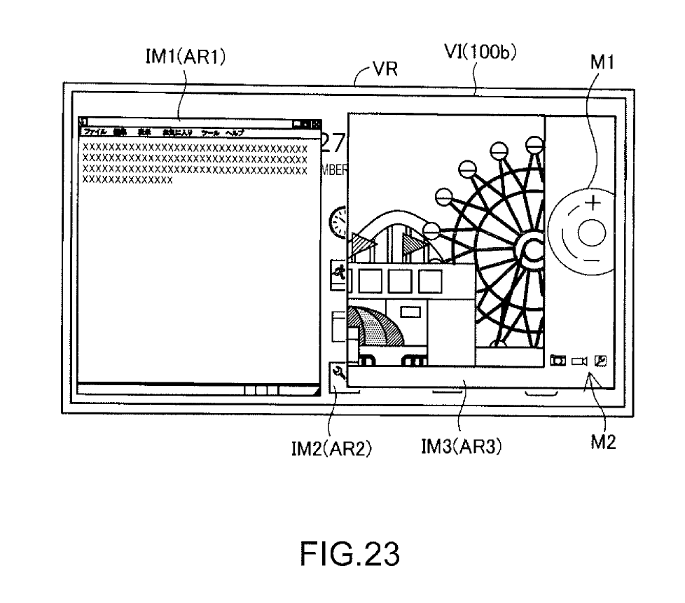

FIG. 23 is a diagram illustrating steps S600 to S606 of a notification process of the third embodiment. FIG. 23 illustrates a state in which a list image is displayed on the head mounted display 100b.

For example, the user of the head mounted display 100b performs a certain operation (for example, an editing operation such as text input or text deletion, an authentication operation of a document, or a save operation) on a document application which is displayed as the image IM1. At this time, step S600 of the notification process (FIG. 22) is executed, and thus a coordinate related to the operation and operation content are transmitted to the head mounted display 100x. In addition, step S602 of the notification process is executed, and thus the operation content of the user of the head mounted display 100b is reflected in the document application of the head mounted display 100x.

In addition, for example, the user of the head mounted display 100b performs a certain operation (for example, a zoom-in or zoom-out operation, a shutter pressing operation, or a setting operation) on a camera application which is displayed as the image IM3. Also in this case, steps S604 and S606 of the notification process are executed, and thus the operation content of the user of the head mounted display 100b is reflected in the camera application of the head mounted display 100y.

As mentioned above, according to the third embodiment, even in a case where a plurality of apparatuses as external apparatuses are connected, the same effect as the effect of the first embodiment can be achieved.

### D. Modification Examples

In the above-described embodiments, some of the constituent elements implemented by hardware may be implemented by software, and, conversely, some of the configurations implemented by software may be implemented by hardware. In addition, the following modifications may also occur.

### Modification Example 1

In the above-described embodiments, a configuration of the image display system has been exemplified. However, any configuration of the image display system may be defined within the scope without departing from the spirit of the invention, and, for example, each device forming the image display system may be added, deleted, changed, or the like. In addition, a network configuration of the device forming the image display system may be changed.

For example, a head mounted display may be connected to a plurality of external apparatuses (for example, a smart phone and a PDA). In this case, in the same manner as in the first and second embodiments, the generation unit may generate a list image in which a display image of a first external apparatus, a display image of a second external apparatus, and a display image of an m-th (where m is an integer of 3 or more) external apparatus are arranged side by side. Accordingly, the image display unit allows a user to visually recognize a list image in which an image of the head mounted display and display images of the plurality of external apparatuses connected to the head mounted display are arranged side by side, as a virtual image. It is possible to further improve convenience for a user in the head mounted display.

For example, a cloud server using the Internet INT may be used instead of the smart phone in the above-described embodiments. In addition, in a case where a plurality of external apparatuses are connected to the head mounted display, a cloud server using the internet INT may be used as at least one of the external apparatuses. Even in this case, the generation unit performs the same process as the process in the first and second embodiments, and thus it is possible to achieve the same effect as the effect of the first embodiment and the second embodiment.

For example, the function of the generation unit of the head mounted display of the embodiments may be provided by an information processing apparatus different from the head mounted display. For example, a cloud server using the Internet INT may be used as the information processing apparatus. In this case, the information processing apparatus includes an acquisition unit which acquires a first image which is a display image of an external apparatus connected to the head mounted display and a second image of the head mounted display, a list image generation unit which generates a list image including the acquired first image and second image, and a list image transmission unit which transmits the generated list image to the head mounted display. The list image generation unit performs the same process as the process of the generation unit of the head mounted display described in the above embodiments, so as to generate a list image to be transmitted to the head mounted display.

### Modification Example 2

In the above-described embodiments, a configuration of the head mounted display has been exemplified. However, any configuration of the head mounted display may be defined within the scope without departing from the spirit of the invention, and, for example, each configuration unit may be added, deleted, changed, or the like.

In the above-described embodiments, the allocation of the constituent elements to the control unit and the image display unit are only an example, and may employ various aspects. For example, the following aspects may be employed: (i) an aspect in which a processing function such as a CPU and a memory is mounted in the control unit, and only a display function is mounted in the image display unit; (ii) an aspect in which a processing function such as a CPU and a memory is mounted in both the control unit and the image display unit; (iii) an aspect in which the control unit and the image display unit are integrally formed (for example, an aspect in which the image display unit includes the control unit and functions as a wearable computer); (iv) an aspect in which a smart phone or a portable game machine is used instead of the control unit; (v) an aspect in which the control unit and the image display unit are configured to communicate with each other and to be supplied with power in a wireless manner so as to remove the connection unit (cords); and (vi) an aspect in which the touch pad is removed from the control unit, and the touch pad is provide in the image display unit.

In the above-described embodiments, for convenience of description, the control unit is provided with the transmission unit, and the image display unit is provided with the reception unit. However, both of the transmission unit and the reception unit of the above-described embodiments have a bidirectional communication function, and thus can function as a transmission and reception unit. In addition, for example, the control unit illustrated in FIG. 5 is connected to the image display unit via the wired signal transmission path. However, the control unit and the image display unit may be connected to each other via a wireless signal transmission path such as a wireless LAN, infrared communication, or Bluetooth (registered trademark).

For example, configurations of the control unit and the image display unit illustrated in FIG. 2 may be arbitrarily changed. Specifically, for example, the control unit may be provided with not only the above-described various input devices (a touch pad, a cross key, a foot switch, a gesture detection device, a visual line detection device, and a microphone) but also various input devices (for example, an operation stick, a keyboard, and a mouse). For example, in the above-described embodiments, a secondary battery is used as the power supply, but the power supply is not limited to the secondary battery and may use various batteries. For example, a primary battery, a fuel cell, a solar cell, and a thermal cell may be used.

For example, in the above-described embodiments, the head mounted display is a binocular transmission type head mounted display, but may be a monocular head mounted display. In addition, the head mounted display may be a non-transmissive head mounted display through which external scenery is blocked from being transmitted in a state in which the user wears the head mounted display. Further, as an image display unit, instead of the image display unit which is worn as glasses, other types of image display units such as an image display unit which is worn as, for example, a cap, may be employed. In addition, the earphone may employ an ear-mounted type or a head band type, or may be omitted. Further, for example, a head-up display (HUD) may be configured to be mounted in a vehicle such as an automobile or an airplane. Furthermore, for example, the head mounted display may be configured to be built in a body protection tool such as a helmet.

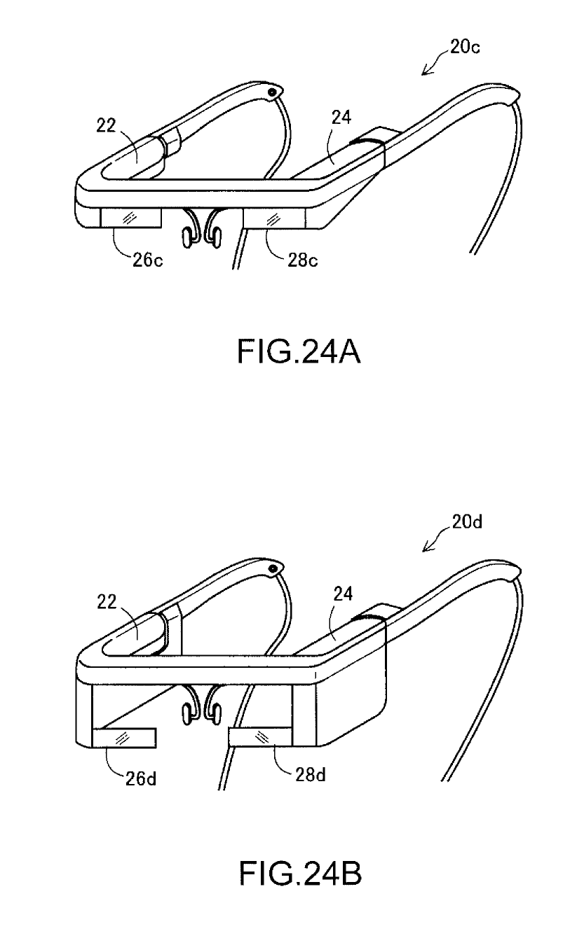

FIGS. 24A and 24B are diagrams illustrating exterior configurations of head mounted displays in a modification example. In an example of FIG. 24A, an image display unit 20c includes a right optical image display unit 26c instead of the right optical image display unit 26 and a left optical image display unit 28c instead of the left optical image display unit 28. The right optical image display unit 26c and the left optical image display unit 28c are formed to be smaller than the optical members of the first embodiment, and are disposed on the obliquely upper side of the right eye and the left eye of the user when the head mounted display is mounted. In an example of FIG. 24B, an image display unit 20d includes a right optical image display unit 26d instead of the right optical image display unit 26 and a left optical image display unit 28d instead of the left optical image display unit 28. The right optical image display unit 26d and the left optical image display unit 28d are formed to be smaller than the optical members of the first embodiment, and are disposed on the obliquely lower side of the right eye and the left eye of the user when the head mounted display is mounted. As above, the optical image display units have only to be disposed near the eyes of the user. Any size of the optical member forming the optical image display units may be used, and the head mounted display may be implemented in an aspect in which the optical image display units cover only a part of the eyes of the user; in other words, the optical image display units do not completely cover the eyes of the user. In addition, also in a case where the configurations as in FIGS. 24A and 24B are employed, it is possible to appropriately adjust an arrangement of the first image and the second image in a list image so as to be a mode suitable for the head mounted display while improving visibility from a user. In this case, an arrangement is not limited to the examples of an arrangement described in the above embodiments.

For example, in the above-described embodiments, the display driving unit is configured using the backlight, the backlight control portion, the LCD, the LCD control portion, and the projection optical system. However, the above aspect is only an example. The display driving unit may include a configuration unit for implemented other types along with this configuration unit or instead of this configuration unit. For example, the display driving unit may include an organic electroluminescent (EL) display, an organic EL controller, and a projection optical system. In addition, for example, the display driving unit may use a digital micromirror device may be used instead of the LCD. Further, for example, the invention is applicable to a laser retinal projective head mounted display.

For example, description has been made that the function units such as the generation unit, notification unit the image processing unit, the display control unit, and the sound processing unit are implemented by the CPU developing a computer program stored in the ROM or the hard disk on the RAM and executing the program. However, these function units may be configured using an application specific integrated circuit (ASIC) which is designed for implemented each of the corresponding functions.

### Modification Example 3

In the above-described embodiments, an example of the arrangement process has been described. However, the procedure of the arrangement process is only an example, and various modifications may occur. For example, some steps may be omitted, and other steps may be added. In addition, an order of executed steps may be changed.

For example, the generation unit may generate a list image without using region information. Specifically, in step S116, the generation unit may generate a list image by disposing the first image and the second image at predefined coordinate positions, instead of the region information. As another example, in step S116, the generation unit may generate a list image by disposing the first image and the second image at coordinate positions which are dynamically calculated from acquired sizes of the first image and the second image. Accordingly, it is possible to generate a list image without needing the region information.

For example, the enlargement or reduction process of the first and second images in step S114 may be omitted. In addition, for example, either one of the authentication of the smart phone in step S104 and the establishment of connection in step S106 may be omitted, and an order to be executed may be changed.

For example, a list image described in the above embodiments is assumed to be an image which is expressed in a two-dimensional manner. However, the image processing unit may express a list image in a three-dimensional manner by making right eye image data and left eye image data different from each other.

For example, the generation unit makes pointer images which are superimposed and drawn on the first and second images of a list image different from each other. However, the generation unit may instruct the OS to make a pointer image which is superimposed and drawn in the first region of a list image different from a pointer image which is superimposed and drawn in the second region.

For example, as the pointer image which is superimposed and drawn in the first image of a list image and the pointer image which is superimposed and drawn in the second image, images which have the same shape but are different in colors or decorations may be used.

For example, an image which is currently operated by a user may be visually recognized by using other methods instead of using a pointer image superimposed and drawn on the first image of a list image and a pointer image superimposed and drawn on the second image as different images. Specifically, the transmittance of one of images which are currently operated by the user may be reduced, and the transmittance of the other image may be increased. In addition, a color conversion process for enhancing an image as compared with external scenery may be performed on one of images which are currently operated by the user, and a color conversion process for assimilating the external scenery to the image may be performed on the other image. Further, a decoration may be added to one of images which are currently operated by the user, and no decoration may be added to the other image. As mentioned above, images which are currently operated by the user can be visually recognized by using the transmittance, colors, or presence or absence of decorations of the first image and second image.

For example, in the second embodiment, the generation unit may generate the second image without using a frame. Specifically, the generation unit may generate the second image by disposing an icon image at a predefined coordinate position. As another example, the generation unit may generate the second image by disposing an icon image at a coordinate position which is dynamically calculated from an acquired size of the icon image. Accordingly, it is possible to generate the second image without needing frame information.

For example, in the second embodiment, the generation unit may dynamically generate the second image so as to avoid a visual line direction of a user. Specifically, a configuration (also referred to as a “visual line direction detection unit”) of detecting a visual line direction, such as a camera capturing an image of the eyes of the user or an infrared sensor, is added to the above-described head mounted display. The generation unit may preferentially select an image list which is separated from a detected visual line direction from among a plurality of image lists with frames, so as to arrange icon images. Accordingly, it is possible to arrange dynamic icon images which avoid a visual line direction of a user in the second image.

### Modification Example 4

In the above-described embodiments, an example of the notification process has been described. However, the procedure of the notification process is only an example, and various modifications may occur. For example, some steps may be omitted, and other steps may be added. In addition, an order of executed steps may be changed.

### Modification Example 5

In the above-described embodiment (FIG. 3), an example of the region information stored in the region information storage portion has been described. However, details of the region information are only an example, and various modifications may occur. For example, constituent elements may be added, deleted, or changed.

For example, a plurality of pieces of region information may be stored in the region information storage portion. In addition, a frame used when a list image is generated may be selected on the basis of any condition such as a preference (setting) of a user of a head mounted display, a motion of a visual line of a user, a motion of the head of a user, or ambient brightness.

### Modification Example 6

In the second embodiment (FIG. 11), an example of a frame stored in the frame information has been described. However, details of the frame are only an example, and various modifications may occur. For example, constituent elements may be added, deleted, or changed.

For example, a plurality of frames may be stored in the frame information. In addition, a frame used when a second image is generated may be selected on the basis of any condition such as a preference (setting) of a user of a head mounted display, a motion of a visual line of a user, a motion of the head of a user, or ambient brightness.

For example, the frame has been described to include two image lists LT1 and LT2. However, the number of image lists include in the frame may be one or three or more. In addition, a shape, a size and the number of image frames in the image list may be arbitrarily set. Further, a size (aspect ratio) of a region of the frame may not be the same as a size (aspect ratio) of the second region of region information.

### Modification Example 7

The invention is not limited to the above-described embodiments or modification examples, and may be implemented using various configurations within the scope without departing from the spirit thereof. For example, the embodiments corresponding to technical features of the respective aspects described in Summary and the technical features in the modification examples may be exchanged or combined as appropriate in order to solve some or all of the above-described problems, or in order to achieve some or all of the above-described effects. In addition, if the technical feature is not described as an essential feature in the present specification, the technical feature may be deleted as appropriate.

The entire disclosure of Japanese Patent Application Nos. 2013-183631, filed Sep. 5, 2013 and 2014-106842, filed May 23, 2014 are expressly incorporated by reference herein.

What is claimed is:

1. A head mounted display which allows a user to visually recognize a virtual image and external scenery, comprising:
a generation unit that generates a list image including a first image which is a display image of an external apparatus connected to the head mounted display and a second image of the head mounted display; and
an image display unit that forms the virtual image indicating the generated list image.

2. The head mounted display according to claim 1, further comprising:
an acquisition unit that acquires the first image from the external apparatus,
wherein the generation unit generates the list image in which the acquired first image is disposed in a first region, and the second image is disposed in a second region different from the first region.

3. The head mounted display according to claim 1,
wherein the generation unit uses an image which is currently displayed on the head mounted display as the second image.

4. The head mounted display according to claim 1,
wherein the generation unit generates the second image by changing an arrangement of icon images of the head mounted display.

5. The head mounted display according to claim 4,
wherein the generation unit further performs at least one of change of shapes, change of transmittance, change of colors, change of sizes, and addition of decorations, on the icon image when the second image is generated.

6. The head mounted display according to claim 1,
wherein the generation unit further changes a size of at least one of the first image and the second image, and generates the list image by using the changed image.

7. The head mounted display according to claim 1,
wherein the generation unit further performs a process corresponding to at least one of change of shapes, change of transmittance, change of colors, change of sizes, and addition of decorations, on at least one of the first image and the second image, and generates the list image by using the image having undergone the process.

8. The head mounted display according to claim 1, further comprising:
an operation acquisition unit that acquires an operation on the list image performed by the user; and
a first notification unit that notifies the external apparatus of the operation when the acquired operation is an operation on the first image.

9. The head mounted display according to claim 1,
wherein the image display unit forms the virtual image in which a pointer image is further superimposed on the list image, and
wherein the generation unit makes the pointer image superimposed on the first image different from the pointer image superimposed on the second image.

10. The head mounted display according to claim 9,
wherein the generation unit further performs at least one of change of shapes, change of transmittance, change of colors, change of sizes, and addition of decorations, on at least one of the pointer image superimposed on the first image and the pointer image superimposed on the second image, so as to make the pointer images different from each other.

11. The head mounted display according to claim 1,
wherein the image display unit forms the virtual image in which a pointer image is further superimposed on the list image, and
wherein the head mounted display further includes
a second notification unit that notifies the external apparatus of positional information for superimposing a pointer image for the external apparatus at a position corresponding to a position at which the pointer image is superimposed in a display image of the external apparatus, when the pointer image is superimposed on the first image.

12. The head mounted display according to claim 9,
wherein the image display unit forms the virtual image in which the pointer image is superimposed, at a position determined on the basis of at least one of a motion of an indicator on an input device of the head mounted display and a motion of a visual line of the user.

13. The head mounted display according to claim 2,
wherein the acquisition unit acquires the first image from the external apparatus, and acquires a third image which is a display image of another external apparatus from another external apparatus, and
wherein the generation unit generates the list image in which the third image is disposed in a third region different from the first region and the second region.

14. A method for controlling a head mounted display, comprising:
(a) generating a list image including a first image which is a display image of an external apparatus connected to the head mounted display and a second image of the head mounted display; and
(b) forming the virtual image indicating the generated list image.

15. A computer program causing a computer to implemente:
a function of generating a list image including a first image which is a display image of an external apparatus connected to a head mounted display and a second image of the head mounted display; and
a function of forming the virtual image indicating the generated list image in the head mounted display.

16. An image display system comprising:
a head mounted display that allows a user to visually recognize a virtual image and external scenery; and
an external apparatus that is connected to the head mounted display,
wherein the external apparatus includes
a transmission unit that acquires a first image which is a display image of the external apparatus, and transmits the acquired first image to the head mounted display, and
wherein the head mounted display includes
a generation unit that generates a list image including the first image and a second image of the head mounted display; and
an image display unit that forms the virtual image indicating the generated list image.

17. An information processing apparatus which is connected to a head mounted display and generates an image to be displayed on the head mounted display, the apparatus comprising:
an acquisition unit that acquires a first image which is a display image of an external apparatus connected to the head mounted display and a second image of the head mounted display;
a list image generation unit that generates a list image including the acquired first image and second image; and
a list image transmission unit that transmits the generated list image to the head mounted display.
